(19) United States
(12) Patent Application Publication
(10) Pub. No.: US 2019/0065677 A1
(43) Pub. Date: Feb. 28, 2019

(54) MACHINE LEARNING BASED ANTIBODY DESIGN

(71) Applicant: Massachusetts Institute of Technology, Cambridge, MA (US)

(72) Inventors: David K. Gifford, Boston, MA (US); Haoyang Zeng, Cambridge, MA (US); Ge Liu, Cambridge, MA (US)

(73) Assignee: Massachusetts Institute of Technology, Cambridge, MA (US)

(21) Appl. No.: 16/171,596

(22) Filed: Oct. 26, 2018

Related U.S. Application Data
(63) Continuation of application No. PCT/US2018/013641, filed on Jan. 12, 2018.
(60) Provisional application No. 62/446,169, filed on Jan. 13, 2017.

(51) Int. Cl. G06F 19/22; G06F 19/24; G06F 19/18; G06F 19/16; G06N 3/08; G06F 19/12

(52) U.S. Cl. CPC G06F 19/22; G06F 19/24; G06F 19/12; G06F 19/16; G06N 3/08; G06F 19/18

(57) ABSTRACT

Described herein are techniques for more precisely identifying antibodies that may have a high affinity to an antigen. The techniques may be used in some embodiments for synthesizing entirely new antibodies for screening for affinity, and for more efficiently synthesizing and screening antibodies by identifying, prior to synthesis, antibodies that are predicted to have a high affinity to the antigen. In some embodiments, a machine learning engine is trained using affinity information indicating a variety of antibodies and affinity of those antibodies to an antigen. The machine learning engine may then be queried to identify an antibody predicted to have a high affinity for the antigen.

### CROSS-REFERENCE TO RELATED APPLICATIONS

This application claims priority under 35 U.S.C. § 119(e) to U.S. Provisional Application Ser. No. 62/446,169, titled “Machine Learning Based Antibody Design,” filed on Jan. 13, 2017, the entire contents of which are incorporated herein by reference.

### GOVERNMENT SUPPORT

This invention was made with government support under Grant No. R01 HG008363 awarded by the National Institutes of Health. The government has certain rights in the invention.

### BACKGROUND

An antibody is a protein that binds to one or more antigens. Antibodies have regions called complementarity-determining regions (CDRs) that impact the binding affinity to an antigen based on the sequence of amino acids that form the region. A high affinity level may form a stronger bond between an antibody and an antigen, while a low affinity level may form a weaker bond. The degree of affinity with an antigen may vary among different antibodies such that some antibodies have a high affinity level or a low affinity level with the same antigen.

### SUMMARY

According to some embodiments, a method for identifying an antibody amino acid sequence having an affinity with an antigen is provided. The method may include receiving an initial amino acid sequence for an antibody having an affinity with the antigen and querying a machine learning engine for a proposed amino acid sequence for an antibody having an affinity with the antigen higher than the affinity of the initial amino acid sequence.

In some embodiments, querying the machine learning engine comprises inputting the initial amino acid sequence to the machine learning engine. The machine learning engine was trained using affinity information to a target for different amino acid sequences. The method may further include receiving from the machine learning engine the proposed amino acid sequence. The proposed amino acid sequence may indicate a specific amino acid for each residue of the proposed amino acid sequence.

In some embodiments, receiving the proposed amino acid sequence includes receiving values associated with different amino acids for each residue of a sequence, where the values correspond to predictions, of the machine learning engine, of affinities of the proposed amino acid sequence if the amino acid is included in the proposed amino acid sequence at the residue, and identifying the proposed amino acid sequence by selecting, for each residue of the sequence, an amino acid having a highest value from among the values for different amino acids for the residue. In some embodiments, querying a machine learning engine for a proposed amino acid sequence and identifying the proposed amino acid sequence are performed successively.

In some embodiments, the method further includes querying the machine learning engine for a second proposed amino acid sequence successively to receiving from the machine learning engine the proposed amino acid sequence. In some embodiments, querying the machine learning engine for the second proposed amino acid sequence comprises by inputting the proposed amino acid to the machine learning engine.

In some embodiments, the method further includes training the machine learning engine using affinity data associated with the proposed amino acid sequence and querying the machine learning engine for a second proposed amino acid sequence having an affinity with the antigen higher than the affinity of the initial amino acid sequence. In some embodiments, the proposed amino acid sequence includes a complementarity-determining region (CDR) of an antibody.

In some embodiments, the method further includes receiving affinity information associated with an antibody having the proposed amino acid sequence with the antigen and training the machine learning engine using the affinity information. In some embodiments, the method further comprises predicting an affinity level for the proposed amino acid sequence, comparing the predicted affinity level to affinity information associated with an antibody having the proposed amino acid sequence with the antigen, and training the machine learning engine based on a result of the comparison.

In some embodiments, the method further comprises identifying a region of the initial amino acid sequence associated with a binding region of the antibody associated with the initial amino acid sequence and querying the machine learning engine further comprises inputting the binding region of the initial amino acid sequence to the machine learning engine. In some embodiments, the binding region of the initial amino acid sequence is a CDR.

According to some embodiments, method for identifying a series of discrete attributes by applying a model generated by a machine learning engine trained using training data that relates the discrete attributes to a characteristic of series of the discrete attributes is provided. The method includes receiving an initial series of discrete attributes as an input into the model. Each of the discrete attributes is located at a position within the initial series and is one of a plurality of discrete attributes. The method further includes querying the machine learning engine for an output series of discrete attributes having a level of the characteristic that differs from a level of the characteristic for the initial series. Querying the machine learning engine may include inputting the initial series of discrete attributes to the machine learning engine. The method further includes receiving from the machine learning engine, in response to the querying, an output series and values associated with different discrete attributes for each position of the output series. The values for each discrete attribute for each position correspond to predictions of the machine learning engine regarding levels of the characteristic if the discrete attribute is selected for the position. The method further includes identifying a discrete version of the output series by selecting, for each position of the series, the discrete attribute having the highest value from among the values for different discrete attributes for the position and receiving as an output of identifying the discrete version a proposed series of discrete attributes.

In some embodiments, the querying, the receiving the output series, and the identifying the discrete version of the output series form at least part of an iterative process and the method further includes at least one additional iteration of the iterative process, wherein in each iteration, the querying comprises inputting to the machine learning engine the discrete version of the output series from an immediately prior iteration. In some embodiments, the iterative process stops when a current output series matches a prior output series from the immediately prior iteration.

In some embodiments, the discrete attributes includes different amino acids and the characteristic of series of discrete attributes corresponds to an affinity level of an antibody with an antigen. In some embodiments, the machine learning engine includes at least one convolutional neural network.

According to some embodiments, a method for identifying an amino acid sequence for a protein having an interaction with another protein is provided. The method comprises receiving an initial amino acid sequence for a first protein having an interaction with a target protein and querying a machine learning engine for a proposed amino acid sequence for a protein having an interaction with the target protein higher than the interaction of the initial amino acid sequence. Querying the machine learning engine may comprise inputting the initial amino acid sequence to the machine learning engine. The machine learning engine may have been trained using protein interaction information for different amino acid sequences. The method further comprises receiving from the machine learning engine the proposed amino acid sequence, the proposed amino acid sequence indicating a specific amino acid for each residue of the proposed amino acid sequence.

In some embodiments, receiving the proposed amino acid sequence further comprises receiving values associated with different amino acids for each residue of a peptide sequence. The values may correspond to predictions, of the machine learning engine, of protein interactions of the proposed amino acid sequence if the amino acid is included in the proposed amino acid sequence at the residue. Receiving the proposed amino acid sequence further comprises identifying the proposed amino acid sequence by selecting, for each residue of the peptide sequence, an amino acid having a highest value from among the values for different amino acids for the residue. In some embodiments, querying a machine learning engine for a proposed amino acid sequence and identifying the proposed amino acid sequence are performed successively.

In some embodiments, the method further comprises querying the machine learning engine for a second proposed amino acid sequence successively to receiving from the machine learning engine the proposed amino acid sequence. In some embodiments, querying the machine learning engine for the second proposed amino acid sequence comprises by inputting the proposed amino acid to the machine learning engine.

In some embodiments, the method further comprises training the machine learning engine using protein interaction data associated with the proposed amino acid sequence and querying the machine learning engine for a second proposed amino acid sequence having a protein interaction with the target protein stronger than the protein interaction of the initial amino acid sequence. In some embodiments, the method further comprises receiving protein interaction information associated with an antibody having the proposed amino acid sequence with the target protein and training the machine learning engine using the protein interaction information.

In some embodiments, the method further comprises predicting a protein interaction level for the proposed amino acid sequence, comparing the predicted protein interaction level to protein interaction information associated with a protein having the proposed amino acid sequence with the target protein, and training the machine learning engine based on a result of the comparison. In some embodiments, the method further comprises identifying a region of the initial amino acid sequence associated with a protein interaction region of the first protein associated with the initial amino acid sequence and querying the machine learning engine further comprises inputting the protein interaction region of the initial amino acid sequence to the machine learning engine.

According to some embodiments, a method for identifying an antibody amino acid sequence having a quality metric is provided. The method comprises receiving initial amino acid sequences for antibodies each with an associated quality metric, and using the initial amino acid sequences and associated quality metrics to train a machine learning engine to predict the quality metric for at least one sequence that is different from the initial amino acid sequences. The method further comprises querying the machine learning engine for a proposed amino acid sequence for an antibody having a high quality metric for a sequence that is different from the initial amino acid sequences and receiving from the machine learning engine the proposed amino acid sequence, the proposed amino acid sequence indicating a specific amino acid for each residue of the proposed amino acid sequence.

In some embodiments receiving the proposed amino acid sequence comprises receiving values associated with different amino acids for each residue of a sequence. The values may correspond to predictions, of the machine learning engine, of quality metrics of the proposed amino acid sequence if the amino acid is included in the proposed amino acid sequence at the residue. Receiving the proposed amino acid sequence further comprises identifying the proposed amino acid sequence by selecting, for each residue of the sequence, an amino acid having a highest value from among the values for different amino acids for the residue.

In some embodiments, querying a machine learning engine for a proposed amino acid sequence and identifying the proposed amino acid sequence are performed successively. In some embodiments, the method further comprises querying the machine learning engine for a second proposed amino acid sequence successively to receiving from the machine learning engine the proposed amino acid sequence. In some embodiments, querying the machine learning engine for the second proposed amino acid sequence comprises by inputting the proposed amino acid to the machine learning engine.

In some embodiments, the method further comprises training the machine learning engine using quality metric data associated with the proposed amino acid sequence and querying the machine learning engine for a second proposed amino acid sequence having a quality metric with the antigen higher than the quality metric of the initial amino acid sequence. In some embodiments, the method further comprises receiving quality metric information associated with an antibody having the proposed amino acid sequence and training the machine learning engine using the quality metric information. In some embodiments, the method further comprises predicting a quality metric level for the proposed amino acid sequence, comparing the predicted quality metric level to quality metric information associated with an antibody having the proposed amino acid sequence, and training the machine learning engine based on a result of the comparison.

In some embodiments, the method further comprises identifying a region of the initial amino acid sequence associated with a binding region of the antibody associated with the initial amino acid sequence and querying the machine learning engine further comprises inputting the region of the initial amino acid sequence to the machine learning engine.

According to some embodiments, at least one computer-readable storage medium storing computer-executable instructions that, when executed by at least one processor, cause the at least one processor to perform a method according to the techniques described above.

According to some embodiments, an apparatus comprising control circuitry configured to perform a method according to the techniques described above.

### BRIEF DESCRIPTION OF THE DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1 illustrates components of an exemplary system that identifies proposed amino acid sequences using a machine learning engine trained on initial amino acid sequence(s) and quality metric data.

FIG. 2 is a flowchart illustrating an exemplary method for identifying proposed amino acid sequence(s) by training a machine learning engine trained on initial amino acid sequence(s) and quality metric data.

FIG. 3 is a flowchart illustrating an exemplary method for identifying a proposed amino acid sequence by selecting an amino acid for each residue from among different amino acids for the residue based on values generated by querying a machine learning engine.

FIG. 4 is a flowchart illustrating an exemplary method for predicting quality metric(s) for the proposed amino acid sequences, which may be used in training a machine learning engine.

FIG. 5 is a flowchart illustrating an exemplary method for identifying a series of discrete attributes by applying a model generated by a machine learning engine trained using training data that relates the discrete attributes to a characteristic of the series of the discrete attributes.

FIG. 6 is a flowchart illustrating an exemplary method for identifying an amino acid sequence by training a machine learning engine trained on initial amino acid sequence(s) and data identifying first and second characteristics of the initial amino acid sequences.

FIG. 7A is a schematic of an antibody having three hypervariable complementarity-determining regions (CDRs) that are major determinants of their target affinity and specificity.

FIG. 7B is a schematic of employing machine learning methods to iteratively improve antibody designs.

FIG. 7C is a schematic of a deep learning process that may successfully adapt to biological tasks and infer functional properties directly from a sequence.

FIG. 8A is a graph demonstrating that panning results are consistent across replicates and can separate antibody sequences by affinity CDR sequences have almost identical enrichment from Pre-Pan to Pan-1 across two technical replicates.

FIG. 8B is a plot of counts of sequences obtained by concatenating the three CDR sequences as representative proxies for each underlying complete antibody sequence.

FIG. 8C is a plot of counts of antibody sequences that were enriched in Pan-1 were assigned three labels: weak-binders (B), mid-binders (C), and strong-binders (D) depending upon their enrichment in Pan-2.

FIG. 9A is a plot of true positive rate versus false positive rate and demonstrates how CNN (seq_64×2_5_4) outperforms other methods in identifying high binders, and performance is random when training labels are randomly permuted showing that the CNN is not simply memorizing the input.

FIG. 9B is a plot showing that training on random down sampling of the training data show a monotonic increase in classification performance with increasing amounts of training data.

FIG. 10 is a plot of observed binding affinity to influenza hemagglutinin versus predicted binding affinity using a CNN trained to predict affinity to influenza hemagglutinin from amino acid sequences.

FIG. 11A is a plot predicted affinity predicted using a CNN demonstrating distinguishing between D predicted amino acid sequences from held-out C amino acid sequences.

FIG. 11B is a plot of true positive rate versus false positive rate illustrating ROC classification performance for training on labeled B and C and testing on held-out C vs. D using CNN and KNN machine learning methods and a CNN control with permuted training labels.

FIG. 12 is a schematic of how CNN can suggest novel high-scoring sequences.

FIG. 13 is a plot of true positive rate versus false positive rate illustrating auROC classification of CNN and KNN on randomly held-out 20% test set for class 1 (Lucentis) and class 2 (Enbrel) data.

FIG. 14A is a plot of the correlation between observed enrichment and enrichment predicted by multi-output regression CNN on held-out 20% test set for class 1 (Lucentis).

FIG. 14B is a plot of the correlation between observed enrichment and enrichment predicted by multi-output regression CNN on held-out 20% test set for class 2 (Enbrel).

FIG. 15 is a boxplot of predicted class 1 (Lucentis) score of positive training set and held-out 0.1% sequences.

FIG. 16 is a boxplot of predicted class 2 (Enbrel) score of specific Lucentis binders and non-specific Lucentis binders, where the specific binders have much lower predicted score on Enbrel.

FIG. 17 is a plot of true positive rate versus false positive rate illustrating an ROC curve of a trained classification CNN on predicting a class 2 (Enbrel) label for held out 0.1% sequences.

FIG. 18A is a distribution plot of predicted Lucentis CNN score for seed sequences, which may be used to train a CNN.

FIG. 18B is a distribution plot of predicted Lucentis CNN score for novel sequences proposed by a gradient ascent based on an optimization method.

FIG. 18C is a distribution plot of predicted Enbrel CNN score for seed sequences, which may be used to train a CNN.

FIG. 18D is a distribution plot of predicted Enbrel CNN score for novel sequences proposed by a gradient ascent based on an optimization method.

FIG. 19 is a block diagram of a computing device with which some embodiments may operate.

### DETAILED DESCRIPTION

Described herein are techniques for more precisely identifying antibodies that may have a high affinity to an antigen. The techniques may be used in some embodiments for synthesizing entirely new antibodies for screening for affinity, and for more efficiently synthesizing and screening antibodies by identifying, prior to synthesis, antibodies that are predicted to have a high affinity to the antigen. In some embodiments, a machine learning engine is trained using affinity information indicating a variety of antibodies and affinity of those antibodies to an antigen. The machine learning engine may then be queried to identify an antibody predicted to have a high affinity for the antigen.

The machine learning engine may be trained based on attributes of an antibody other than affinity and may output a proposed antibody based on the attributes. In some embodiments, such other attributes may include measurements of a quality of an antibody. In some embodiments, one quality metric may be antibody specificity can be measured by experimentally measuring affinity of an antibody to one or more undesired control targets. Specificity is then defined as the negative of the inverse of the affinity of an antibody for a control target. In this manner, a machine learning engine can be trained to predict and optimize for specificity, or any other quality metric that can be experimentally measured. Examples of quality metrics that a machine learning engine can be trained on include affinity, specificity, stability (e.g., temperature stability), solubility (e.g., water solubility), lability, cross-reactivity, and any other suitable type of quality metric that can be measured. In some embodiments, the machine learning engine may have multi-task functionality and allow for simultaneous prediction and optimization of multiple quality metrics.

In embodiments that implement such a machine learning engine, the query may be performed in various ways. The inventors have recognized and appreciated the advantages of a particular form of query, in which a known amino acid sequence, corresponding to one antibody, is input to the machine learning engine as part of the query. The query may request the machine learning engine identify amino acids sequence with a higher predicted affinity for the antigen than the affinity of the input amino acids sequence for the antigen. As output, the machine learning engine may produce an amino acid sequence that is predicted to have a higher affinity, with that amino acid sequence corresponding to an antibody that is predicted to have the higher affinity for the antigen. In some embodiments, multiple amino acid sequences corresponding to different antibodies may be used as a query to the machine learning engine, and the machine learning engine may produce an amino acid sequence that is predicted to have a higher affinity for an antigen than some or all of the antibodies.

In some embodiments, using as a guide the amino acid sequence that is output by the machine learning engine, a new antibody may be synthesized that includes the amino acid sequence, and the new antibody may be screened to determine its affinity. The determined affinity and the amino acid sequence may, in some embodiments, then be used to update the machine learning engine. The updated machine learning engine may then be used in identifying subsequent amino acid sequences.

The inventors have recognized and appreciated that designing and synthesizing antibodies that have specifically-identified amino acid sequences and are predicted to have higher affinity for one or more particular antigens can improve the applicability and use of antibodies in a variety of biological technologies and treatments, including cancer and infectious disease therapeutics. Conventional techniques of developing new potential antibodies included a biological randomization process where different antibodies were randomly synthesized, such as through a random mutation process of the amino acid sequence of an antibody that is known to have some amount of affinity with the antigen. Such a random mutation process produces an unknown antibody with an unknown series of amino acids, and with an unknown affinity for an antigen. Following the mutation, the new antibody would be tested to determine whether it had an acceptable affinity for an affinity and, if so, would be analyzed to determine the affinity for the antigen. The inventors recognized and appreciated that such a process was unfocused and inefficient, and led to wasted resources in testing and synthesizing antibodies that would ultimately have low affinity or would not have higher affinity than known antibodies, or would be found to be identical to a previously-known antibody.

The inventors recognized and appreciated the advantages that would be offered by a system for identifying specific proposals for antibodies to be synthesized, which would have specific series of amino acids, and that would be predicted to have high affinities for an antigen. By identifying specific candidate antibodies and specific series of amino acids, new antibodies may be synthesized in a targeted way to include the identified series of amino acids, as opposed to the randomized techniques previously used. This can reduce waste of resources and improve efficiency of research and development. Further, because the targeted antibody that is synthesized is predicted to have a high affinity, resources can be only or primarily invested in the synthesis and screening of antibodies that may ultimately be good candidates, further reducing waste and increasing efficiency.

Described herein are techniques for identifying an amino acid sequence for an antibody having an affinity with a particular antigen. In some embodiments, an amino acid sequence for an antibody is identified as having a predicted affinity, with the predicted affinity of the identified antibody being higher than an affinity of an antibody used as an input in a process for identifying the antibody. The identified antibody amino acid sequence can be subsequently evaluated by synthesizing an antibody having the sequence and performing an assay that assesses the affinity of the antibody to a particular target antigen. A process used to identify an antibody amino acid sequence having a predicted affinity with a target antigen may include computational techniques that relate amino acids in a sequence to affinity of the corresponding antibody, which can be derived from data obtained by performing assays that evaluate affinity of one or more antibodies with an antigen. According to some embodiments described herein, machine learning techniques can be applied by developing a machine learning engine trained on data that relates amino acid sequences to affinity with an antigen and querying the machine learning engine for a proposed amino acid sequence having an affinity with the antigen. Querying the machine learning engine may include inputting an initial amino acid sequence for an antibody having an affinity with the antigen.

In some embodiments, a machine learning engine operating according to techniques described herein may output a specific series of amino acids corresponding to a new antibody to be synthesized. The inventors have recognized and appreciated, however, that in some cases, the machine learning engine may implement techniques for optimization of an output that relates an amino acid sequence to affinity information. An output of such an optimization process may include, rather than a specific antibody or a specific series of amino acids, a sequence of values where each position of the sequence corresponds to a residue of an amino acid sequence of an antibody, and where each position of the sequence has multiple values that are each associated with different amino acids and/or types of amino acids. The values may be considered as a “continuous” representation of an amino acid sequence having a high affinity, with the values correlating to an affinity of an antibody including that amino acid or type of amino acid at that residue of the antibody's amino acid sequence. The inventors recognized and appreciated that while such a “matrix” of values for an amino acid sequence may be a necessary byproduct of an optimization process, but may present difficulties in synthesizing an antibody for screening. In contrast to such a range of continuous values for each residue, a biologically occurring amino acid sequence of an antibody is discrete, having only one type of amino acid at each residue. The inventors recognized and appreciated, therefore, that in embodiments in which a machine learning process implements an optimization, it may be helpful in some embodiments to process the continuous-value data set to arrive at a discrete representation of an antibody, which can be synthesized and screened.

The inventors further recognized and appreciated, however, that a discretization of a continuous-value data set produced by an optimization process may eliminate some of the optimization achieved through the optimization process. The inventors therefore recognized and appreciated the advantages of an iterative process for discretization of optimized values. In some embodiments of such an iterative process, the continuous representation of the proposed amino acid sequence output by the machine learning engine, following a query such as that discussed above (for identifying an antibody with a higher predicted affinity), may be converted into a discrete representation, before being an input into the machine learning engine during a subsequent iteration. The subsequent iteration may again include the same type of query for an antibody with a higher predicted affinity, and may again produce a continuous-value data set for amino acids at residues of the antibody. In some embodiments, the iterative process may continue until the discrete amino acid sequence of one iteration is the same as the discrete amino acid sequence input to the iteration. In some embodiments, the iterative process may continue until a predicted affinity of the discrete amino acid sequence with the antigen of one iteration is the same as a predicted affinity of a subsequently proposed amino acid sequence. In such cases, it may be considered that the iterative optimization and discretization process has converged. Alternatively, in some embodiments, a fixed number of iterations may continue after the iterative optimization and discretization process converges and the sequence having the highest predicted affinity is selected.

In some embodiments, instead of using a known antibody sequence as input to the machine learning engine, a random sequence is input as a query for an antibody with higher affinity. The machine learning engine may then optimize the random sequence to a sequence for an antibody with high predicted affinity for the antigen data that was used to train the machine learning engine. This optimization may consist of one or more iterations of optimization by the machine learning engine. By using different random input sequences, multiple antibody candidates with predicted high affinity may be generated.

In some embodiments that include such a continuous representation, each residue of an amino acid sequence may have values associated with different types of amino acids where the values correspond to predictions of affinities of the amino acid sequence generated by the machine learning engine. The inventors have recognized and appreciated that one iterative process of the type described above may include selecting, at each iteration, for each residue the amino acid having the highest value for that residue of the sequence, to convert from a continuous-value representation to a discrete representation. The proposed amino acid sequence having the discrete representation may be successively inputted into the machine learning engine during a subsequent iteration of the process. In some embodiments, a continuous-value proposed amino acid sequence received from the machine learning engine as an output in an iteration may include different continuous values associated with amino acids for each residue of a sequence, and as a result of selecting the highest-value amino acids for each residue, between iterations a different discrete amino acid sequence may be identified.

In some embodiments, the machine learning engine may be updated by training the machine learning engine using affinity information associated with a proposed amino acid sequence. Updating the machine learning engine in this manner may improve the ability of the machine learning engine in proposing amino acid sequences having higher affinity levels with the antigen. In some embodiments, training the machine learning engine may include using affinity information associated with an antibody having the proposed amino acid sequence with the antigen. For example, in some embodiments, training the machine learning engine may include predicting an affinity level for the proposed amino acid sequence, comparing the predicted affinity level to affinity information associated with an antibody having the proposed amino acid sequence, training the machine learning engine based on a result of the comparison. If the predicted affinity is the same or substantially similar to the affinity information, then the machine learning engine may be minimally updated or not updated at all. If the predicted affinity differs from the affinity information, then the machine learning engine may be substantially updated to better correct for this discrepancy. Regardless of how the machine learning engine is retrained, the retrained machine learning engine may be used to propose additional amino acid sequences for antibodies.

Although the techniques of the present application are in the context of identifying antibodies having an affinity with an antigen, it should be appreciated that this is a non-limiting application of these techniques as they can be applied to other types of protein-protein interactions. Depending on the type of data used to train the machine learning engine, the machine learning engine can be optimized for different types of proteins, protein-protein interactions, and/or attributes of a protein. In this manner, a machine learning engine can be trained to improve identification of an amino acid sequence, which can also be referred to as a peptide, for a protein having a type of interaction with a target protein. Querying the machine learning engine may include inputting the initial amino acid sequence for a first protein having an interaction with a target protein. The machine learning engine may have been previously trained using protein interaction information for different amino acid sequences. The query to the machine learning engine may be for a proposed amino acid sequence for a protein having an interaction with the target protein higher than the interaction of the initial amino acid sequence. A proposed amino acid sequence indicating a specific amino acid for each residue of the proposed amino acid sequence may be received from the machine learning engine.

The inventors further recognized and appreciated that the techniques described herein associated with iteratively querying a machine learning engine by inputting a sequence having a discrete representation, receiving an output from the machine learning engine that has a continuous representation, and discretizing the output before successively providing it as an input to the machine learning engine, can be applied to other machine learning applications. Such techniques may be particularly useful in applications where a final output having a discrete representation is desired. Such techniques can be generalized for identifying a series of discrete attributes by applying a model generated by a machine learning engine trained using data relating the discrete attributes to a characteristic of a series of the discrete attributes. In the context of identifying an antibody, the discrete attributes may include different amino acids and the characteristic of the series corresponds to an affinity level of an antibody with an antigen.

In some embodiments, the model may receive as an input an initial series having a discrete attribute located at each position of the series. Each of the discrete attributes within the initial series is one of a plurality of discrete attributes. Querying the machine learning engine may include inputting the initial series of discrete attributes and generating an output series of discrete attributes having a level of the characteristic that differs from a level of the characteristic for the initial series. In response to querying the machine learning engine, an output series and values associated with different discrete attributes for each position of the output series may be received from the machine learning engine. For each position of the series, the values for each discrete attribute may correspond to predictions of the machine learning engine regarding levels of the characteristic if the discrete attribute is selected for the position and form a continuous value data set. The values may range across the discrete attributes for a position, and may be used in identifying a discrete version of the output series. In some embodiments, identifying the discrete version of the output series may include selecting, for each position of the series, the discrete attribute having the highest value from among the values for the different discrete attributes for the position. A proposed series of discrete attributes may be received as an output of identifying the discrete version.

In some embodiments, an iterative process is formed by querying the machine learning engine for an output series, receiving the output series, and identifying a discrete version of the output series. An additional iteration of the iterative process may include inputting the discrete version of the output series from an immediately prior iteration. The iterative process may stop when a current output series matches a prior output series from the immediately prior iteration.

The inventors have further recognized and appreciated advantages of identifying a proposed amino acid sequence having desired values for multiple quality metrics (e.g., values higher than values for another sequence), rather than a desired value for a single quality metric, including for training a machine learning engine to identify an amino acid sequence with multiple quality metrics. Such techniques may be particularly useful in applications where identification of a proposed amino acid sequence for a protein having different characteristics is desired. In implementations of such techniques, the training data may include data associated with the different characteristics for each of the amino acid sequences used to train a machine learning engine. A model generated by training the machine learning engine may have one or more parameters corresponding to different combinations of the characteristics. In some embodiments, a parameter may represent a weight between a first characteristic and a second characteristic, which may be used to balance a likelihood that a proposed amino acid sequence has the first characteristic in comparison to the second characteristic. In some embodiments, training the machine learning engine includes assigning scores for different characteristics, and the scores may be used to estimate values for parameters of the model that are used to predict a proposed amino acid sequence. For some applications, identifying a proposed amino acid sequence having both affinity with a target protein and specificity for the target protein may be desired. Training data in some such embodiments may include amino acid sequences and information identifying affinity and specificity for each of the amino acid sequences, which when used to train a machine learning engine generates a model having a parameter representing a weight between affinity and specificity used to predict a proposed amino acid sequence. Training the machine learning engine may involve assigning scores for affinity and specificity, and a value for the parameter may be estimated using the scores.

Described below are examples of ways in which the techniques described above may be implemented in different embodiments. It should be appreciated that the examples below are merely illustrative, and that embodiments are not limited to operating in accordance with any one or more of the examples.

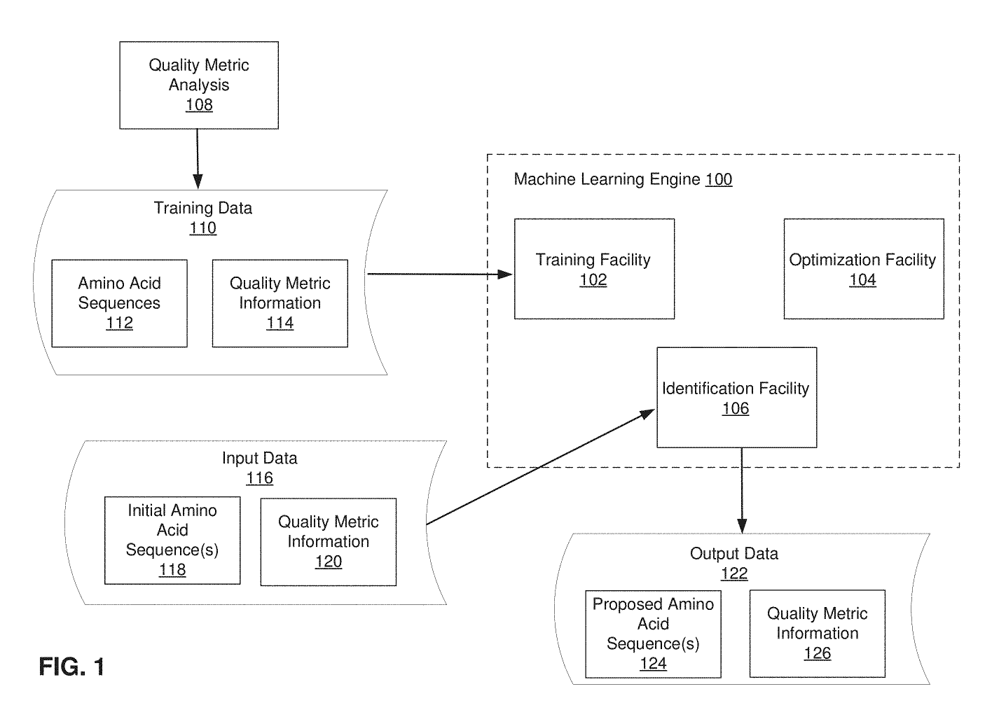

FIG. 1 illustrates an amino acid identification system with which some embodiments may operate. The amino acid identification system of FIG. 1 includes machine learning engine 100 having training facility 102, optimization facility 104, and identification facility 106. Training facility 102 may receive training data 110, which includes amino acid sequence(s) 112 and quality metric information 114, and use the training data to train machine learning engine 100 for identifying proposed amino acid sequences by identification facility 106. In some embodiments, identifying a proposed amino acid sequence may involve identification facility 106 querying machine learning engine 100 by inputting an initial amino acid sequence to the trained machine learning engine 100. Identification facility 106 receives from the machine learning engine 100 output data 122, which includes the proposed amino acid sequence(s) 124, where the proposed amino acid sequence indicates a specific amino acid for each residue of a proposed amino acid sequence. The proposed amino acid sequence 124 may differ from initial amino acid sequence(s) 118. Output data 122 received from the machine learning engine 100 may also include quality metric information 126 associated with the proposed amino acid sequence(s) 124, including characteristic(s) of a protein having a proposed amino acid sequence.

Identification of an amino acid sequence may include querying machine learning engine 100 by inputting input data 116, which may include initial amino acid sequence(s) 118 and quality metric information 120 associated with initial amino acid sequence(s) 118. Identification facility 106 may apply input data 116 to a trained machine learning engine 100 to generate output data 122, which may include proposed amino acid sequence(s) 124. In some embodiments, output data 122 may include quality metric information 126 associated with proposed amino acid sequence(s) 124.

Training facility 102 may generate a model through training of machine learning engine 100 using training data 110. The model may relate discrete attributes (e.g., amino acids in a sequence) in positions (e.g., residue) of a series of discrete attributes (e.g., amino acid sequence) to a level of a characteristic of a series of discrete attributes having a particular discrete attribute in a position. The model may have a convolutional neural network (CNN), which may have any suitable of convolution layers. Examples of models generated by training a machine learning engine using training data is discussed further below.

In some embodiments, a model generated by training a machine learning engine may include one or more parameter(s) representing relationships between quality metric(s) and/or series of amino acids in a sequence, and optimization facility 104 may estimate value(s) for the parameter(s). Some embodiments may involve generating a model that that jointly represents a first characteristic and a second characteristic of an amino acid sequence, and model may have a parameter representing a weight between the first characteristic and the second characteristic. In such embodiments, training the machine learning engine may involve using training data that includes a plurality of amino acid sequences and information identifying the first characteristic and the second characteristic corresponding to each of the plurality of amino acid sequences. A value for the parameter may indicate whether a proposed amino acid sequence has a higher likelihood of having the first characteristic or the second characteristic, and the value for the parameter may be used by identification facility 106 for identifying proposed amino acid sequence(s) 124. In some embodiments, training facility 102 may assign scores for the first characteristic or the second characteristic correspond to each of the initial amino acid sequences, and optimization facility 104 may estimate value(s) for parameter(s) using the scores. Optimization facility 104 may apply a suitable optimization process to estimate value(s) for parameter(s), which may include applying gradient ascent optimization algorithm. It should be appreciated that a model generated by training a machine learning engine may represent a combination of any suitable number of characteristics and have parameters balancing different combinations of the characteristics and optimization facility 104 may estimate a value for each of the parameters using the scores assigned during training of the machine learning engine.

A parameter of the model may correspond to a variable in a mathematical expression relating score(s) associated with different characteristics, depending on what types of characteristics are desired in the proposed amino acid sequences identified by the machine learning engine. In some implementations, the model may be generated to relate a high level for a first characteristic (Class 1) and a low level for a second characteristic (Class 2), and a parameter used in the model may represent a variable in a mathematical expression where subtraction is used to relate the scores for the first and second characteristics. An example of such an expression is Score(Class 1)−α*Score(Class 2), where a parameter, α, is a weighted variable applied to the scores for the second characteristic. In contrast, the model may be generated to relate high levels for both a first characteristic and a high level of a second characteristic, and a parameter used in the model may represent a variable in a mathematical expression where addition is used to relate the scores for the first and second characteristics. An exemplary expression is Score(Class 1)+β*Score(Class 2). It should be appreciated that these techniques may be extended to generate models for any suitable number of characteristics and parameters. An example of expression having multiple parameters is Score(Class 1)−α*Score(Class 2)+β*Score(Class 3), where Score(Class 1), Score(Class 2), and Score(Class 3) correspond to scores for first, second, and third characteristics, and α and β are parameters of the model.

Amino acid sequences 112 of training data 110, initial amino acid sequence(s) 118 of input data 118, and proposed amino acid sequence(s) 124 of output data 122 may correspond to the same or similar region of a protein having the amino acid sequence. In some embodiments, individual amino acid sequences 112, initial amino acid sequence(s) 118, and proposed amino acid sequence(s) 124 may correspond to a binding region of a protein (e.g., a complementarity-determining region (CDR)). In applications involving identifying a proposed amino acid sequence of an antibody, the proposed amino acid sequence may include a complementarity-determining region (CDR) of the antibody. In some embodiments, individual amino acid sequences 112, initial amino acid sequence(s) 118, and proposed amino acid sequence(s) 124 may correspond to a region of a receptor (e.g., T cell receptor). In some embodiments, a query to machine learning engine 100 may include a distribution of amino acid sequences, which may act as a random initialization, instead of or in combination with initial amino acid sequence(s) 118.

Quality metric information 114 of training data 110, quality metric information 120 of input data 116, and quality metric information 126 of output data 122 may include quality metric(s) that identify particular characteristic(s) associated with a protein having an amino acid sequence 112 of the training data 110, an initial amino acid sequence 118 of the input data 116, and a proposed amino acid sequence 124 of the output data 122, respectively. Examples of quality metric(s) that may be included as quality metric information are affinity, specificity, stability (e.g., temperature stability), solubility (e.g., water solubility), lability, and cross-reactivity. For example, quality metric information may include an affinity level of a protein (e.g., antibody, receptor) having a particular amino acid sequence with a target protein. In some embodiments, quality metric information may include multiple affinity levels corresponding to a protein interactions of a protein having a particular amino acid sequence with different proteins. In some embodiments, training data 110 may include estimated quality metric information. In some embodiments, input data 116 may lack quality metric information.

Some embodiments may include quality metric analysis 108, as shown in FIG. 1, which may include one or more processes and/or one or more devices, configured to generate training data 110. Suitable assays for assessing one or more quality metrics of proteins having amino acid sequences 112 may be implemented as part of quality metric analysis 108. In some embodiments, an assay used to generate training data 110 may involve measuring interaction between a particular protein with one or more target proteins. As an example, to assess affinity of a particular protein with a target protein, quality metric analysis 108 may include performing phage panning experiments, which are discussed in further detail below. As yet another example, quality metric analysis 108 may involve performing yeast display to obtain affinity data associated with amino acid sequences used to train a machine learning engine. Other types of training data that may be used to train a machine learning engine include molecular weight of an amino acid sequence, isoelectric point of an amino acid sequence, protein features of an amino acid sequence (e.g., helix regions, sheet regions).

Some embodiments involve denoising or “cleaning” the training data before it is used to train the machine learning engine. For example, data generated by conducting an assay, such as phage panning, may result in amino acid sequences and/or quality metric information having varying consistency and/or quality. To improve consistency of the training data, replicates of the assay may be performed and training data, including amino acid sequences, which are consistent across the different replicates may be inputted as training data. In some embodiments, denoising of training data may involve using data having a quality level that is above or below a threshold amount. For example, in embodiments where phage panning data is used for training a machine learning engine, the number of sequences observed for a particular sequence may indicate the quality of the data, such as whether the results of a phage panning assay indicates that the sequence has an affinity with a target protein. Denoising of the training data may involve using a quality floor to select sequences identified by the phage panning data based on the number of reads observed for a particular sequence. It should be appreciated that training of the machine learning engine may involve using additional training data to reduce or overcome noise present in the training data. In some embodiments, training of a machine learning engine may involve updating the machine learning engine with additional training data until the machine learning engine is trained in a manner to overcome or reduce noise present in the training data.

The proposed amino acid sequences identified by machine learning engine 100 depends on the amino acid sequences 112 and the quality metric information 114 used to train the machine learning engine 100. Training facility 102 may involve training machine learning engine 100 to identify proposed amino acid sequence(s) 124 having one or more particular quality metric(s) depending on the training data 110. In some embodiments, training data 110 may include protein interaction data for different amino acid sequences, and the trained machine learning engine may identify a proposed amino acid sequence for a protein having an interaction with a target protein higher than the interaction of an initial amino acid sequence inputted into the trained machine learning engine. As an example, training data 110 may include affinity information for different amino acid sequences with an antigen, and the trained machine learning engine may identify a proposed amino acid sequence for an antibody having an affinity higher than an affinity of an initial amino acid sequence with the antigen.

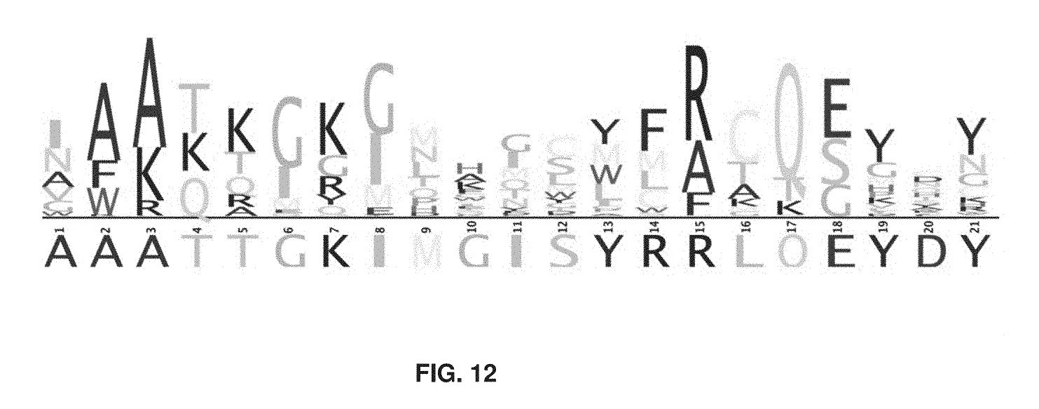

In some embodiments, identification facility 106 may identify a representation of a proposed amino acid sequence having a “continuous” representation that includes values associated with different amino acids for each residue of a sequence. Individual values may correspond to predictions of quality metric(s) of the proposed amino acid sequence if the amino acid associated with the value is included in the proposed amino acid sequence at the residue. For a particular residue, a continuous representation may include a value corresponding to each type of amino acid and may have the format as a vector of the values associated with the residue. Across the residues of an amino acid sequence, the individual vectors of the values may result in a matrix where a row or column of the matrix corresponds to different residues. As there are 21 amino acids, a particular residue may have 21 values in a continuous representation. An example of a continuous representation is visualized in FIG. 12 where the letters correspond to different amino acids and the size of the individual letters represents the value for the amino acid. For example, residue 3 has an “A” that is larger than an “R,” which indicates that the value for “A” is larger than the value for “R” for that residue.

In some embodiments, identification facility 106 may perform a discretization process of a continuous representation by selecting an amino acid for each residue based on the values for the residue. In such embodiments, querying machine learning engine 100 for a proposed amino acid sequence and identifying the proposed amino acid sequence may be performed successively. In some embodiments, identification facility 106 may select, for each residue, an amino acid having a highest value from among the values for different amino acids for the residue. Returning to the example of residue 3 in the continuous representation of FIG. 12, an identification facility may select “A” for the residue because it has the highest value in comparison to the values for amino acids “K” and “R.”

It should be appreciated that other characteristics in addition to or instead of the value of a quality metric may be used in performing a discretization process for a continuous representation of a proposed amino acid sequence. In some embodiments, discretization of a continuous representation of an amino acid sequence may involve selecting an amino acid for a residue based on an amino acid selected for another residue. For example, selection of an amino acid may involve considering whether the resulting amino acid sequence can be produced efficiently. In some embodiments, discretization of a continuous representation of an amino acid sequence may involve selecting an amino acid for a residue based on an amino acid selected for a neighboring residue or a residue proximate to the residue for which the amino acid is being selected. In some embodiments, discretization of a continuous representation of an amino acid sequence may involve selecting an amino acid for a residue based on the selection of amino acids for a subset of other residues in the sequence. In some implementations, the selection process used to discretize a continuous representation of a proposed amino acid may include preferentially selecting one type of amino acid over another. Some amino acids may be indicated as undesirable amino acids to include in a proposed amino acid sequence, such as by an indication based on user input. Those amino acids indicated as undesired amino acids may not be selected by a discretization process even if they have a high value associated with one of those amino acids for a residue. For example, cysteine can form disulfide bonds, which may be viewed as undesirable in some instances. During a discretization process where there is an indication not to select cysteine, an amino acid other than cysteine is selected for residues in the sequence, even if there is a residue having a high value associated with cysteine.

In some embodiments, multiple features may be considered as part of a discretization process by converting a proposed amino acid sequence having a continuous representation into a vector of features, which may be used to predict one or more quality metrics (e.g., affinity). The predicted one or more quality metrics may be used to then identify a proposed amino acid sequence having a discrete representation. Generating the vector of features from a continuous representation of a proposed amino acid sequence may involve using an autoencoder, which may include one or more neural networks trained to copy an input into an output, where the output and the input may have different formats. The one or more neural networks of the autoencoder may include an encoder function, which may be used for encoding an input into an output, and a decoder function, which may be used to reconstruct an input from an output. The autoencoder may be trained to receive a proposed amino acid sequence as an input and generate a vector of features corresponding to the proposed amino acid sequence as an output.

Some embodiments may involve an iterative process, which may include successive iterations of querying the machine learning engine 100 for a second proposed amino acid sequence using a first proposed amino acid sequence identified in a prior iteration. In such implementations, querying the machine learning engine 100 for the second proposed amino acid sequence may involve inputting the first proposed amino acid sequence to the machine learning engine. The iterative process may continue until convergence between the proposed amino acid sequence inputted into the machine learning engine and the outputted proposed amino acid sequence.

Some embodiments may involve subsequent training of machine learning engine 100 using quality metric information associated with the proposed amino acid sequence, where querying the further trained machine learning engine involves identifying a second proposed amino acid sequence that differs from the proposed amino acid sequence. In some embodiments, a protein having the proposed amino acid sequence may be synthesized and one or more quality metrics associated with the protein may be measured to generate quality metric information that may be used along with the proposed amino acid sequence as inputs to train the machine learning engine by training facility 102. In some embodiments, protein interaction data associated with the proposed amino acid sequence may be used to train the machine learning engine, and identification facility 106 may query the machine learning engine for a second proposed amino acid sequence having a protein interaction with a target protein that is stronger than a protein interaction with an initial amino acid sequence. For example, affinity data associated with the proposed amino acid sequence may be used to train the machine learning engine, and identification facility 106 may query the machine learning engine for a second proposed amino acid sequence having an affinity with a protein (e.g., antigen) higher than the affinity of initial amino acid sequence(s) 112. In some cases, the additional training of the machine learning engine may allow identification facility 106 to query the machine learning engine for a second proposed amino acid sequence having a protein interaction with a target protein that is stronger than the protein interaction of the proposed amino acid sequence used to train the machine learning engine.

Additional methods for identifying proposed amino acid sequences are described below. It should be appreciate that the system shown in FIG. 1, and particularly machine learning engine 100, may be configured to perform any of these methods.

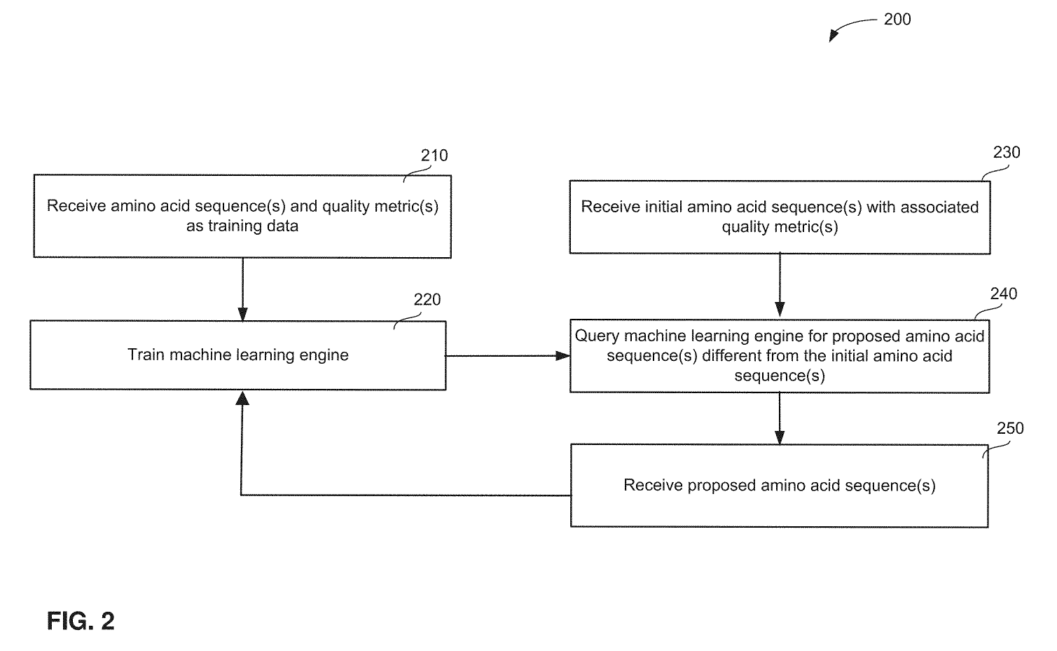

FIG. 2 illustrates an example process 200 that may be implemented in some embodiments to identify an amino acid sequence, which may involve identifying the amino acid sequence to have a quality metric by using a machine learning engine, such as the machine learning engine 100 shown in FIG. 1. The process 200 begins in block 210, in which the machine learning engine receives amino acid sequence(s) and quality metric(s) as training data. In block 220, a training facility associated with the machine learning engine trains a machine learning engine to be used for identifying amino acid sequence(s). In some embodiments, the training data may include protein interaction information for different amino acid sequences. In applications that involve identifying a proposed amino acid sequence of an antibody having an affinity with an antigen, training data may include amino acid sequences and affinity data associated with those amino acid sequences. In some embodiments the amino acid sequences used in training data include sequences associated with a particular region of a protein, such as a complementarity-determining region (CDR) of an antibody.

In block 230, the machine learning engine receives initial amino acid sequence(s) and associated quality metric(s) as input data. In some embodiments, input data may include initial amino acid sequence(s) and lack some or all quality metric(s) associated with the initial amino acid sequence(s). In block 240, the input data is used to query the trained machine learning engine for proposed amino acid sequence(s) that are different from the initial amino acid sequence(s). Input data may include an initial amino acid sequence for a protein having an interaction with a target protein, and querying the machine learning engine may include inputting the initial amino acid sequence to the machine learning engine to identify a proposed amino acid sequence for a protein having an interaction with the target protein higher than the interaction of the initial amino acid sequence. Some embodiments may involve identifying a binding region (e.g., a complementarity-determining region (CDR) of an antibody) of an initial amino acid sequence and querying the machine learning engine by inputting the binding region to the machine learning engine.

In block 250, the proposed amino acid sequence(s) identified by the machine learning engine is received from the machine learning engine. The proposed amino acid sequence may indicate a specific amino acid for each residue of the proposed amino acid sequence. In some embodiments, receiving the proposed amino acid sequence includes receiving values associated with different amino acids for each residue of an amino acid sequence, which may also be referred to as a peptide sequence. The values correspond to predictions, of the machine learning engine, of affinities of the proposed amino acid sequence if the amino acid is included in the proposed amino acid sequence at the residue. Identifying the proposed amino acid sequence may include selecting, for each residue of the sequence, an amino acid having a highest value from among the values for different amino acids for the residue.

Some embodiments involve training the machine learning engine using the proposed amino acid sequence(s). In such embodiments, the proposed amino acid sequence may be used as training data to update the machine learning engine. Subsequent querying of the machine learning engine, which may include inputting the proposed amino acid sequence to the machine learning engine, may include identifying a second proposed amino acid sequence. In some embodiments, updating the machine learning engine may include training the machine learning engine using protein interaction data associated with the proposed amino acid sequence and querying the machine learning engine for a second proposed amino acid sequence having a protein interaction with a target protein that is stronger than the protein interaction of an initial amino acid sequence. In applications that involve identifying a proposed amino acid sequence having affinity with an antigen, training the machine learning engine may involve using affinity data associated with the proposed amino acid sequence and querying the machine learning engine for a second proposed amino acid sequence having an affinity with the antigen higher than the affinity of the initial amino acid sequence.

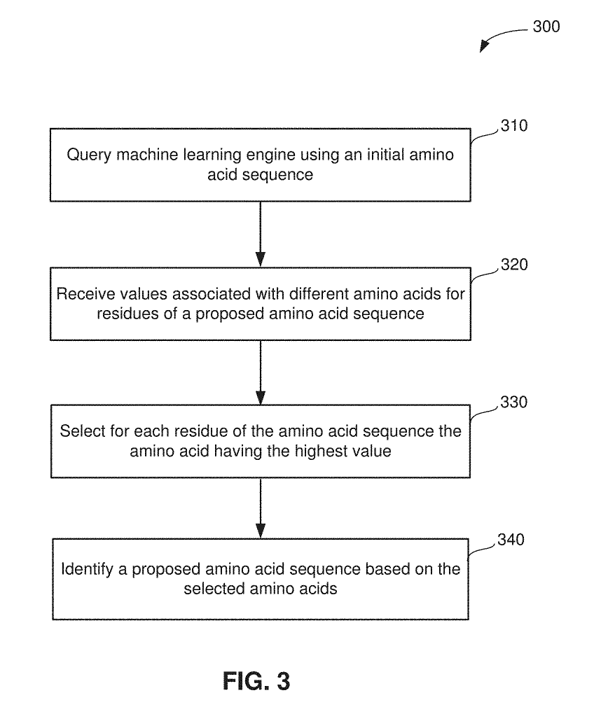

FIG. 3 illustrates an example process 300 that may be implemented in some embodiments to identify a proposed amino acid based on selection, for each residue of the sequence, a particular amino acid based on values generated by a machine learning engine, such as the machine learning engine 100 shown in FIG. 1. The process begins in block 310, which involves querying the machine learning engine using an initial amino acid sequence.

In block 320, an identification facility receives values associated with different amino acids for each residue of an amino acid sequence. The values correspond to predictions, generated by the machine learning engine, of affinities of the proposed amino acid sequence if a particular amino acid is included in the proposed amino acid sequence at the residue. The values for a particular residue represent different possible amino acids to include in the residue, which may be considered as a “continuous” representation of an amino acid sequence.

Identification of a proposed amino acid sequence may involve selecting an amino acid for each residue based on the values associated with the residue to generate an amino acid sequence having a single amino acid corresponding to each residue, which may be considered as a “discrete” representation of an amino acid sequence. In block 330, the identification facility selects for each residue the amino acid having the highest value from among the values for different amino acids for the residue. In block 340, identification facility identifies a proposed amino acid sequence based on the selected amino acids.

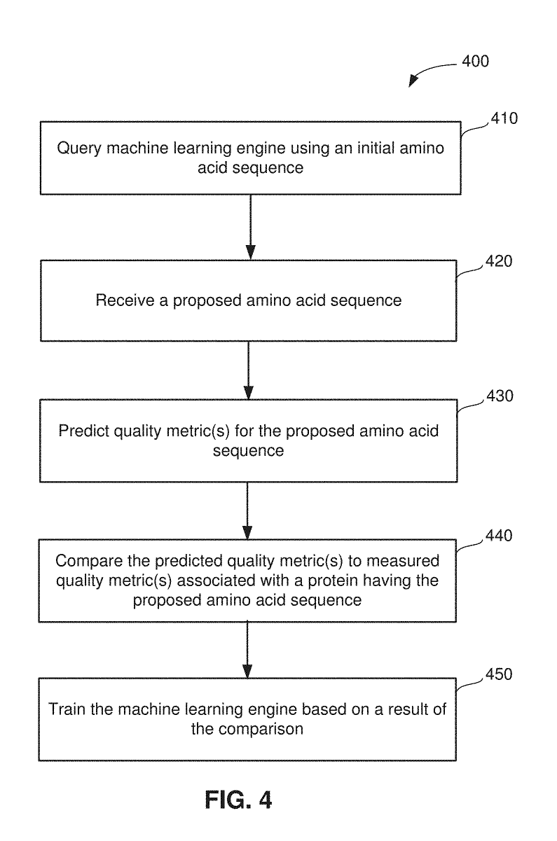

FIG. 4 illustrates an example process 400 that may be implemented in some embodiments using a proposed amino acid sequence identified by a machine learning engine, such as the machine learning engine 100 shown in FIG. 1, to further train the machine learning engine. The process begins in block 410, which involves querying the machine learning engine using an initial amino acid sequence. In block 420, an identification facility receives a proposed amino acid sequence. In block 430, an identification facility predicts quality metric(s) for the proposed amino acid sequence. In block 440, an optimization facility compares the predicted quality metric(s) to measured quality metric(s) associated with a protein having the proposed amino acid sequence. In block 450, a training facility trains the machine learning engine based on a result of the comparison.

In applications where affinity is a quality metric used for identifying a proposed amino acid sequence, process 400 may involve predicting an affinity level for the proposed amino acid sequence, comparing the predicted affinity level to affinity information associated with an antibody having the proposed amino acid sequence with the antigen, and training the machine learning engine based on a result of the comparison.

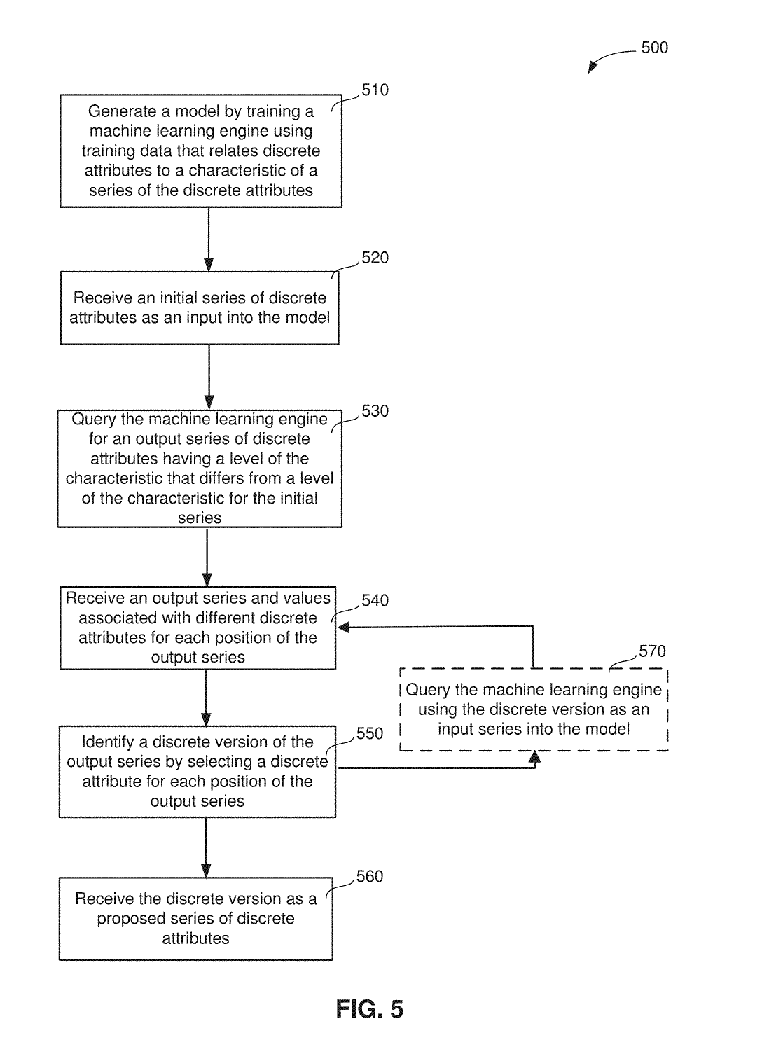

FIG. 5 illustrates an example process 500 that may be implemented in some embodiments to identify a series of discrete attributes, using a machine learning engine, such as the machine learning engine 100 shown in FIG. 1. The process begins in block 510, which involves a training facility generating a model by training the machine learning engine using training data that relates discrete attributes to a characteristic of a series of the discrete attributes. In block 520, an identification facility receives an initial series of discrete attributes as an input into the model. Each of the discrete attributes is located at a position within the initial series and is one of a plurality of discrete attributes.

In block 530, an identification facility queries the machine learning engine for an output series of discrete attributes having a level of the characteristic that differs from a level of the characteristic for the initial series. Querying the machine learning engine includes inputting the initial series of discrete attributes to the machine learning engine.

In block 540, an identification facility receives, in response to querying, an output series and values associated with different discrete attributes for each position of the output series, which may be considered as a continuous version of the output series. The values for each discrete attribute for each position correspond to predictions of the machine learning engine regarding levels of the characteristic if the discrete attribute is selected for the position.

In block 550, an identification facility identifies a discrete version of the output series by selecting a discrete attribute for each position of the output series. In some embodiments, identifying a discrete version of the output series may include selecting, for each position of the series, the discrete attribute having the highest value from among the values for different discrete attributes for the position. In block 560, an identification facility receives the discrete version as a proposed series of discrete attributes.

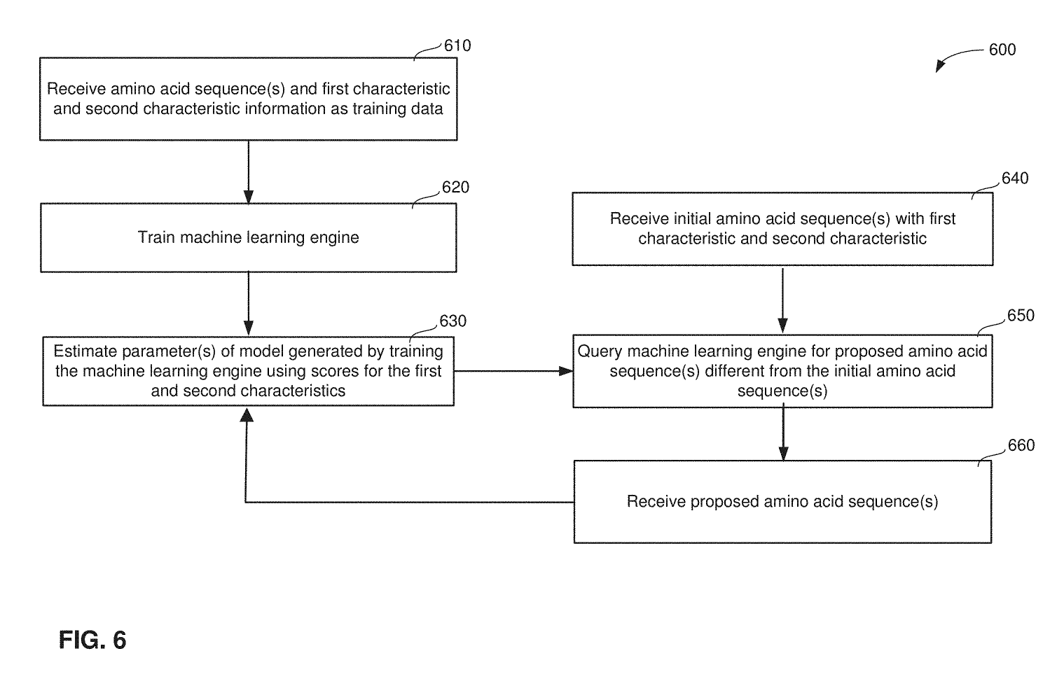

Some embodiments include block 570, which involves identifying the discrete version of the output series using an iterative process where an iteration of the iterative process includes querying the machine learning engine by inputting the discrete version of the output series from an immediately prior iteration. In some embodiments, the iterative process may stop when a current output series matches a prior output series from the immediately prior iteration, which may be considered as convergence of the iterative process. If convergence does not occur, then the iterative process may stop and a prior discretized version of the output series may be rejected as proposed amino acid sequence. For example, if the iterative process begins using an initial discrete version generated by block 550 in response to querying the machine learning engine by block 530 does not converge, then a different discrete version may be identified from the continuous version of the output series. The initial discrete version of the output series that does not result in convergence of the iterative process may be rejected as a proposed amino acid sequence. In some embodiments, the iterative process may stop after a threshold number of iterations occur after inputting a particular discrete version of the output series as an input into the model, which may be considered as a seed series. If the current discrete version of the output series after the iterative process performs the threshold number of iterations has improved in a level of the characteristic in comparison to the seed series, then the current discrete version of the output series may be identified as a proposed series of discrete attributes. Determining whether the current discrete version of the output series has improved in the level of the characteristic may include predicting a level of the characteristic for the current discrete version of the output series. FIG. 6 illustrates an example process 600 that may be implemented in some embodiments to identify an amino acid sequence, which may involve identifying the amino acid sequence to have a first and second characteristic using a machine learning engine, such as the machine learning engine 100 shown in FIG. 1. The process 600 begins in block 610, in which the machine learning engine receives amino acid sequence(s) and first and second characteristic information as training data.

In block 620, a training facility trains the machine learning engine to be used in identification of amino acid sequence(s). Training the machine learning engine may include using the training data to generate a model having parameter(s), including a parameter representing a weight between the first characteristic and the second characteristic that is used to identify the amino acid sequence. Training the machine learning engine may involve assigning scores for the first characteristic and the second characteristic corresponding to individual amino acid sequences in the training data. In block 630, an optimization facility estimates value(s) for the parameter(s) using the scores for the first and second characteristics.

In block 640, an identification facility receives initial amino acid sequence(s) for a protein having a first characteristic and a second characteristic. In block 650, an identification facility queries the machine learning engine for proposed amino acid sequence(s) that differ from the initial amino acid sequence(s). The proposed amino acid sequence may correspond to a protein having an interaction with a target protein that differs from a protein having an initial amino acid sequence. In block 660, an identification facility receives the proposed amino acid sequence(s).

In some embodiments, the first and second characteristics correspond to affinities of a protein for different antigens. In such embodiments, receiving the initial amino acid sequence further comprises receiving an initial amino acid sequence for a protein having an affinity with the antigen higher than with a second antigen. The affinity information used to train the machine learning engine includes affinities for different amino acid sequences with the antigen and the second antigen. Querying the machine learning engine includes applying a model generated by training the machine learning engine that includes a parameter representing a weight between affinity with the antigen and affinity with the second antigen used to predict the proposed amino acid sequence. Training the machine learning engine includes assigning scores for affinity with the antigen and affinity with the second antigen corresponding to each of the plurality of amino acid sequences. Some embodiments may include estimating, using the scores, a value for the parameter and using the value of the parameter to predict the proposed amino acid sequence.

These techniques may be used for identifying a proposed amino acid sequence having an affinity specificity for a particular protein. The training data used to train the machine learning engine may include affinity information for multiple proteins, including a target protein for which it is desired that a proposed amino acid sequence may bind to. An exemplary implementation of these techniques, which is described in further detail below, can be used for identifying proposed amino acid sequences having a high affinity for Lucentis and a low affinity for Enbrel, which implies that the proposed amino acid has specificity for Lucentis. Training data may be obtained by performing phage panning assays to measure binding affinities with Lucentis and Enbrel for different amino acid sequences. Training a machine learning engine may include generating a model having a parameter representing a balance between optimizing binding affinity and specificity and optimizing the model by estimating a value for the parameter using scores assigned to the amino acid sequences. As an example, the model may relate scores assigned to the binding affinity of amino acid sequences to Lucentis and Enbrel by Score(Lucentis)−α*Score(Enbrel) where a is the parameter. A value for the parameters may be estimated using an optimization process, such as a gradient ascent optimization process.

### Illustrative Embodiments

The techniques described herein include a high-throughput methodology for rapidly designing and testing novel single domain (sdAb) and single-chain variable fragment (scFv) antibodies for a myriad of purposes, including cancer and infectious disease therapeutics. This methodology may allow for new applications of human therapeutics by greatly improving the power of present synthetic methods that use randomized designs and providing time, cost, and humane benefits over immunized animal methods. To accomplish this, computationally designed antibody sequences can be assayed using phage display, allowing the displayed antibodies to be tested in a high-throughput format at low cost, and the resulting test data can be used to train molecular dynamics and machine learning methods to generate new sequences for testing. Such computational methods may identify sequences that have ideal properties for target binding and therapeutic efficacy. Such an approach includes training machine learning models from observed affinity data from antigen and control targets. An iterative framework may allow for identification of highly effective antibodies with a reduced number of experiments. Such techniques may propose promising antibody sequences to profile in subsequent assays. Repeated rounds of automated synthetic design, affinity test, and model improvement to produce highly target-specific antibodies may allow for further improvements to the model, which may result in improved identification of proposed amino acid sequences having higher affinities.

Starting with sequencing data from conventional antibody phage display experiments for a target, machine learning models can be trained to estimate the relative binding affinity of unseen antibody sequences for the target. Once such a model is generated, antibody sequences that are designed to improve binding to a target can be predicted and tested. Data from additional experiments may be used to improve the model's ability to accurately predict outcomes. Such models may design previously unseen sequences with both highly uncertain and a range of predicted affinities. These designs can be tested using phage display, and the observed high-throughput affinity data can be used to improve the models to enable the prediction of high-affinity and highly-specific binders. The recent commercialization of array-based oligonucleotide synthesis allows for a million specified DNA sequences to be manufactured at modest cost. The predicted antibody sequences can be synthesized with a range of predicted affinities by our models for a given target using these oligonucleotide services. These sequences can be expressed on high-throughput display platforms, and then affinity experiments followed by sequencing can be performed to determine the accuracy of the models of antibody affinity. The resulting affinity data may be used to further train machine learning models to enable the prediction of highly target-specific antibodies.
These approaches for modeling antibody affinity and specificity from sequence may enable improved human disease therapeutics.
These computational frameworks can also be used to predict and engineer the affinity of receptors for Chimeric Antigen Receptors for T cells (CAR-T cells) for targets of interest, enabling their use for a wider range of human diseases.
Accurate models of antibody binding, availability, and specificity may lead to therapeutic antibodies with improved clinical outcomes.
The techniques described herein may allow for engineering of antibodies for new disease targets for precision medicine-based therapeutics.
The models may predict affinity and other indicators of therapeutic efficacy and safety.
The techniques described herein used for antibody design may provide data on the affinity and specificity of antibodies in vitro, which may aid in selecting appropriate candidates for in vivo therapeutic studies.
The ability to refine antibody designs using training data from high-throughput affinity experiments based upon our synthetic designs may permit the engineering of antibodies suitable for therapeutic and diagnostic reagents faster, more effectively, and at lower cost than existing randomization based methods.
The models may include deep learning models of antibody affinity trained using large training sets derived from high-throughput experiments using high-performance graphic processing units (GPUs).
The models may propose new experiments to test antibody sequences for high-affinity binding to an antigen.

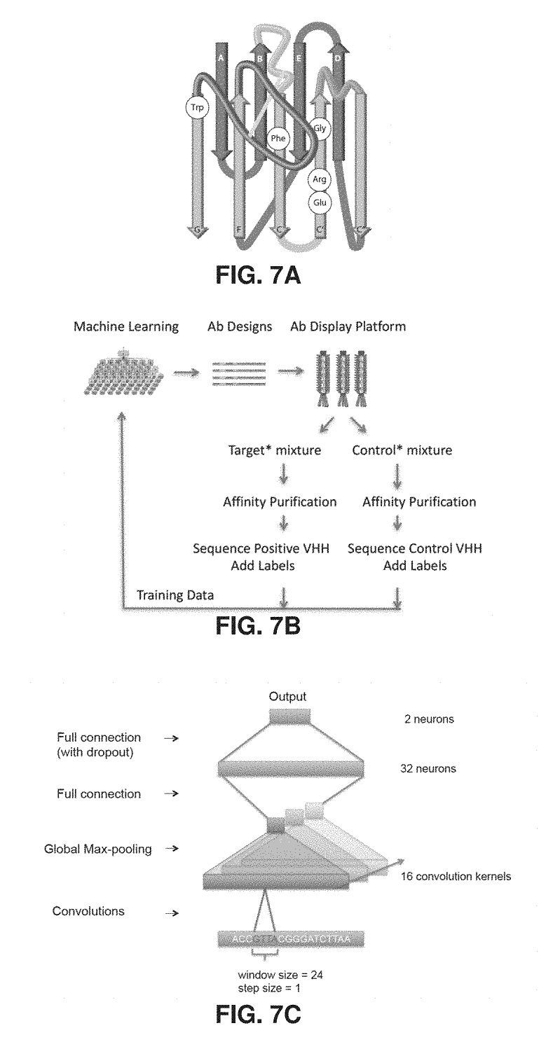

Oligonucleotide synthesis can be used to create and test millions of new antibody candidates to refine the models to allow, which may improve the identification of proposed antibodies.
An iterative loop of high-throughput antibody testing, model training, and antibody design/synthesis may refine the models and enable the characterization of their accuracy.
The models may be trained to recognize other properties of effective therapeutic antibodies including the absence of cross-reactivity to other proteins.
Millions of new antibody sequences that are computationally designed using large-scale commercial oligonucleotide synthesis to produce antibody sequences for high-throughput multiplexed affinity assays followed by sequencing.
Synthesized oligo nucleotide sequences can be used as seeds for biological randomization to expand the sequence space explored by a factor of ten to one hundred.
The models may provide computational estimates of the error in the predictions for a given sequence, and allow for determining sequences that have the most uncertain outcome to enable experiment design to efficiently test sequence space and refine the models.
   One approach of the present application includes designing antibodies with high affinity and high specificity to a target of interest by integrating the disruptive technologies of high-throughput multiplexed affinity experiments, high-throughput DNA sequencing, novel machine learning methods, and large-scale oligonucleotide synthesis (FIG. 7B). FIG. 7B is a schematic of employing machine learning methods to iteratively improve antibody designs by a cycle of testing antibody affinity against targets and controls, labeling the sequencing data from these distinct populations, using these sequencing data to train our models, and creating novel antibodies to test by model generalization and high-throughput oligonucleotide synthesis. The major determinants of the affinity and specificity of both of these types of antibodies are their hypervariable complementarity-determining regions (CDRs, FIG. 7A). FIG. 7A is a schematic of an antibody having three hypervariable complementarity-determining regions (CDRs) that are major determinants of their target affinity and specificity.

For a given target, the computational models may be developed in the framework of:
1) performing an affinity assay of an input antibody library against the target and controls,
2) sequencing the results of the affinity assay,
3) using these labeled sequence data to train a machine learning model to identify antibodies that have high affinity and target specificity,
4) using the model to produce antibody sequences that are predicted to have a range of predicted properties, including sequences that are predicted to have high affinity and sequences where the model is highly uncertain about their properties,
5) using array-based DNA synthesis to create oligonucleotides corresponding to the model-derived sequences and engineering these oligonucleotides into antibody coding sequences for phage or yeast display,
6) characterizing the affinity and specificity of the resulting antibodies with phage or yeast display assays,
7) improvement of the model from these additional data, and
8) returning to step (4) in an iterative cycle of model improvement and testing, repeating steps (4)-(7) until antibodies with desired properties are discovered (FIG. 7B).

Machine learning steps (3), (4), and (7) in the framework may implement a method that can be productively trained on very large data sets of perhaps one hundred million examples and admit interpretation and generalization that may permit both model improvement and the generation of novel sequences that are predicted to have ideal properties. Deep learning methods are capable of learning from very large data sets and suggesting ideal exemplars (LeCun et al., 2015; Szegedy et al., 2015). With the advent of large training data sets and high performance computing, deep learning has revolutionized computational approaches to computer vision (Krizhevsky et al., 2012; Le, 2013; LeCun et al., 2015; Tompson et al., 2014), speech understanding (Hinton et al., 2012; Sainath et al., 2013), and genomics (Alipanahi et al., 2015; Zhou and Troyanskaya, 2015), and now underlies many major Internet services such as Google image search, voice search, and email inbox processing. Deep learning approaches typically outperform conventional methods in precision and recall, and can be used for both classification and regression tasks. One form of deep learning is a convolutional neural network (FIG. 7C) that uses layers of convolutional filters for pattern recognition along with fully connected layers to recognize combinations of patterns. FIG. 7C is a schematic of a deep learning process that has been successfully adapted to biological tasks and can infer functional properties directly from sequence. Convolutional neural networks are trained using labeled examples and typically use large training sets to learn their parameters, and the careful construction of these training sets is essential to avoid model overfitting and high predictive performance.

Convolutional neural networks (CNNs) can be applied to antibody engineering by modeling an antibody sequence as a sequence window with 20 dimensions, one dimension per each possible amino acid at each residue. Thus for an antibody sequence of N amino acids, a CNN may have 20×N inputs where for each residue position only one dimension may be active in a simple “one-hot” encoding. There are alternative encoding methods that involve additional features, and alternative forms of deep learning models can be employed. Sequences with variable length can be used as input after centering and padding them into the same length. The max-pooling units in convolutional neural networks enable position invariance over large local regions and thus guarantee the performance of learning even though the input data is shifted around (Cirean et al., 2011; Krizhevsky et al., 2012). Unlike traditional models, a convolutional neural network (CNN) automatically learns features at different levels of abstraction, from variable length patterns of adjacent amino acids to the manner in which such patterns are combined to produce ideal exemplars. Convolutional neural networks can be efficiently trained on graphical processing units (GPUs), and can easily scale to millions of training examples to learn sophisticated sequence patterns. CNNs may be used for predicting protein-binding from DNA sequence, developing a state of the art model which uncovers relevant sequence motifs (Zeng et al., 2016). CNNs provide the benefit of allowing features associated with short sequences of amino acids to be learned, while retaining the ability to capture complex patterns of sequence combinations in their fully connected layers.

Existing gradient based methods for optimizing a trained deep learning network can suggest the optimal way to change an input value to optimize an output of the network. In our networks the input values are antibody protein sequences, encoded in “one-hot” format, and the output value is the predicted affinity of the input antibody sequence. If existing gradient methods were used to optimize the input values of networks to maximize their output value they would suggest an input value that was not in “one-hot” format, and would at each amino acid position provide multiple non-zero values resulting in an inability to select a protein sequence.

Techniques described herein may allow for improved antibody optimization. First, one type of technique includes discretizing the input value produced by gradient optimization into “one-hot” format by choosing the input in each amino acid position with the highest value resulting in a single optimal sequence, and perform this discretization between rounds of iterative optimization steps to achieve an optimal fixed point despite discretization. Second, the number of continuous space optimization steps between discretization steps can be controlled to ensure that the proposed optimal sequences do not diverge too far from the original input sequence to reduce the chance that the suggested sequence will be non-functional. Such an optimization may be conducted through, for each input sequence, iterating until the suggested one-hot sequence converges:
1) Starting from the one-hot sequence from last iteration, use the forward and backward propagation to conduct k steps of continuous space optimization
2) Embed the optimization results into one-hot sequences by setting the maximum position in each residue to one, and the other positions to zero.

A method to recognize and segment antibody VHH sequences into their constituent 3 CDR regions and 4 framework regions may also be used in some embodiments. Segmentation of the input may allow for identification of the CDR regions for each sequence, which may be inputted into the model. Sequence segmentation may be performed by iteratively running a profile HMM on the sequences. An HMM may be trained for each of the framework region using template sequences provided in the literature. For alpaca VHH sequences proposed by David, et al. in 2007 (https:www:ncbi.nlm/nih.gov/pme/articles/PMC2014515/) can be used. Each HMM may be iteratively run three times to segment out possible framework sequences and retrain the HMMs after each iteration by including newly segmented sequences. Performing such segmentation may improve the consensus sequence used for segmenting framework regions, and thus successfully segment more antibody sequences.

### EXAMPLES

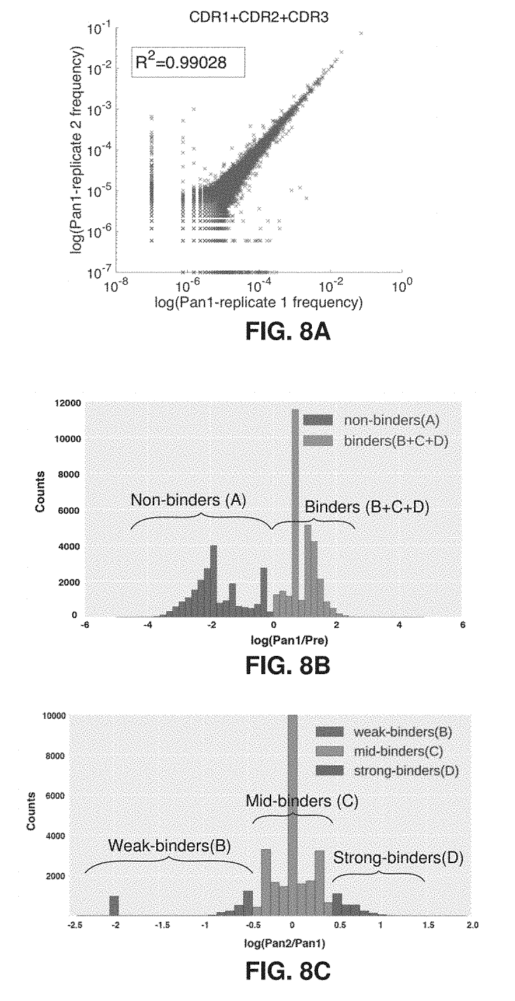

As an example, results of panning based phage display affinity experiments for a single domain (sdAb) alpaca antibody library targeting the nucleoporin Nup120 have been obtained using the techniques described herein. An antibody library was derived from a cDNA library from immune cells from an alpaca immunized with Nup120. We sequenced the antibody repertoire at the input stage of affinity purification (Pre-Pan), the sequences retained after the first round of affinity purification to Nup120 (Pan-1), and the sequences retained from Pan-1 after the second round of affinity purification to Nup120 (Pan-2). We parsed the resulting DNA sequencing reads into complete antibody sequences (complete) as well as their component CDRs (CDR1, CDR2, and CDR3). The frequency of observed complete CDR sequences retained after Pan-1 between technical replicates was highly consistent, with R² values over 0.99 (FIG. 8A). FIG. 8A is a graph demonstrating that panning results are consistent across replicates and can separate antibody sequences by affinity CDR sequences have almost identical enrichment from Pre-Pan to Pan-1 across two technical replicates. We used CDR3 sequences for training and validation, because CDR3 is more diverse compared to other CDRs and it has been considered as the key determinant of specificity in antigen recognition in both T cell receptors (TCR) and antibodies (Janeway, 2001; Rock et al., 1994; Xu and Davis, 2000). The lengths of CDR3 sequences are very diverse, where the average CDR3 length is 17.33, with standard deviation 4.51, which is consistent with previous studies on camelid single domain antibodies (Deschacht et al., 2010; Griffin et al., 2014). We centered and padded the CDR3s into 41 amino acid long sequences and used “one-hot” encoding to represent the sequences, as described in the previous section. We combined replicates and examined the ratio of Pan-1 frequency to Pre-Pan frequency for all sequences that had three occurrences or more in at least one of the three stages. After combining biological replicates we observed 28988 (Pre-Pan), 38479 (Pan-1), and 35476 (Pan-2) antibody sequences after the rejection of poor quality sequence data and the elimination of duplicates. We labeled sequences as non-binders (label A) if they were not enriched in Pan-1 compared to Pre-Pan (FIG. 8B). FIG. 8B is a plot of counts of sequences obtained by concatenating the three CDR sequences as representative proxies for each underlying complete antibody sequence. Antibody sequences that were not enriched in Pan-1 compared to Pre-pan were labeled non-binders. We then labeled the binders into three classes depending on the ratio of the Pan-2 to Pan-1 frequencies (FIG. 8C), weak-binders (B), mid-binders (C), and strong-binders (D). FIG. 8C is a plot of counts of antibody sequences that were enriched in Pan-1 were assigned three labels: weak-binders (B), mid-binders (C), and strong-binders (D) depending upon their enrichment in Pan-2.

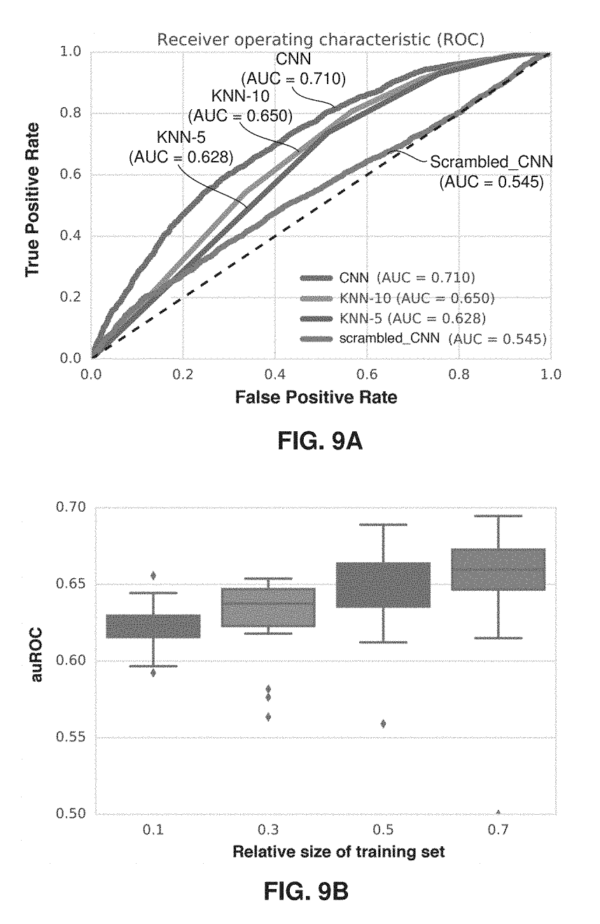

We trained a CNN using the non-binders (A) and mid-binders (C) as the negative and positive sets respectively and examined the model's performance in classifying weak-binders from strong-binders (B vs. D). Thus in this task, the training and test set had completely disjoint ranges of affinity values. We examined the performance of thirteen different CNN architectures and chose the one with the highest area under the receiver operating characteristic curve (auROC) that had two convolutional layers with 64 convolutional kernels in one layer and 128 convolutional kernels in another layer, with a window size of 5 residues and a max pooling step size of 5 residues (Seq_64×2_5_5). Other architectural variants that we tried included one and two convolutional layers, with window sizes ranging from 1 to 10 residues and max pooling step sizes ranging from 3 to 11 residues. Performance ranged from 0.62 auROC to 0.71 auROC. A K-nearest neighbors algorithm that considered 10 neighbors had an AUC of 0.650. Randomizing the input labels during training destroyed performance, as expected (FIG. 9A), and model performance monotonically increases with additional training data (FIG. 9B), suggesting that more data is necessary to achieve optimum classification performance. A CNN may outperform other methods in classifying weak vs. strong binders and performance may improve with more training data. FIG. 9A is a plot of true positive rate versus false positive rate and demonstrates how CNN (seq_64×2_5_4) outperforms other methods in identifying high binders, and performance is random when training labels are randomly permuted showing that the CNN is not simply memorizing the input. FIG. 9B is a plot showing that training on random down sampling of the training data show a monotonic increase in classification performance with increasing amounts of training data. We also found that the network properly classified three sequences that were independently assessed with further targeted validation (one binder, two non-binders).

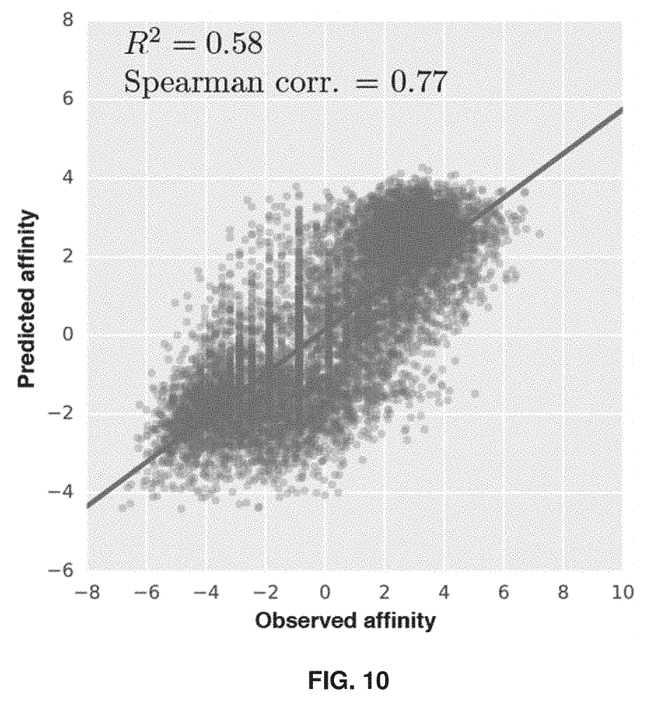

As a complementary exploratory analysis on a published dataset, we analyzed a previous study that synthesized over 50,000 variants of HB80.3, a known influenza inhibitors that binds with nanomolar affinity to influenza hemagglutinin (Fleishman et al., 2011; Whitehead et al., 2012). Using yeast display and fluorescence-activated cell sorting (FACS), the authors determined the binding affinities of each protein variant by quantifying the log ratio of the frequencies in the selected versus unselected population. We applied CNN-based models on this dataset to predict the observed affinity score from amino acid sequence. We randomly split the dataset into a training set and a testing set to evaluate the CNN's ability to generalize to new data. A simple one-layer CNN with 16 convolutional kernels trained on the training set produced predictions for the held out testing set that correlated well with the observed affinity, with an R² of 0.58 and Spearman correlation of 0.767 (FIG. 10). A CNN may accurately predict the binding affinity to influenza hemagglutinin. In FIG. 10, each point represents a sequence held out from training. The x-axis denotes the observed binding affinity and y-axis shows the prediction from a CNN trained to predict affinity to influenza hemagglutinin from amino acid sequence.

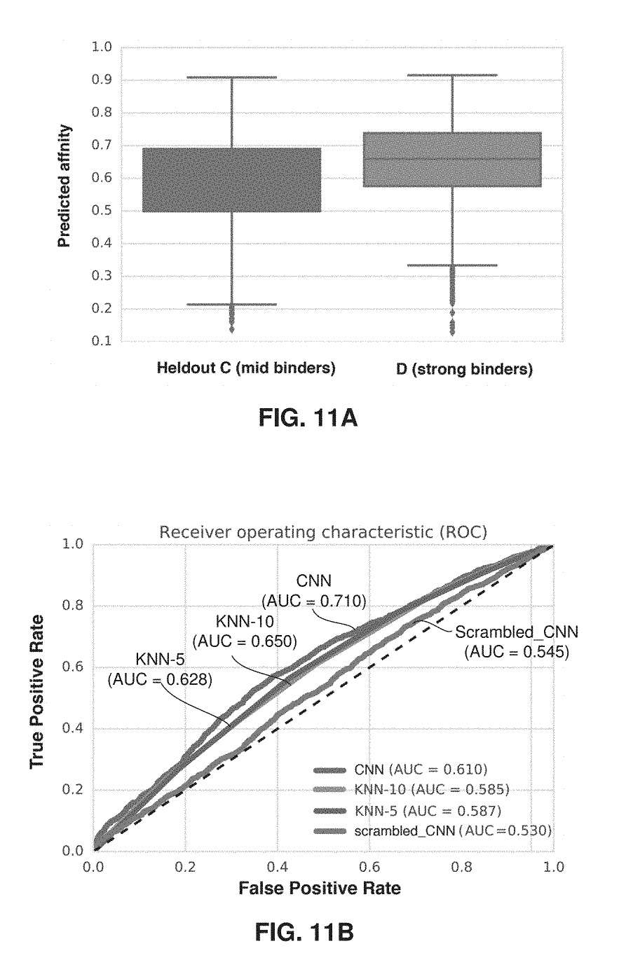

We wanted to ensure that our methods would be able to propose antibody sequences that were better than any previously seen to validate the potential of our approach. We first trained a new CNN and held out the antibodies in our training set with the highest affinity during training. We then asked this model to score set D and found that it assigned scores higher than previously observed (FIG. 11A). A CNN can identify sequences with higher scores than it has observed in training. As shown in FIG. 11A, our optimal CNN (seq_64×2_5_4) when trained on labeled B and C antibody sequences was able to distinguish D sequences from held-out C sequences. The median score of the test set for C and D sequences demonstrate that that the median value of novel D sequences has a higher median than C sequences. (Mann-Whitney U test p-value=1.4×10−42) As shown in FIG. 11B, ROC classification performance for training on labeled B and C and testing on held-out C vs. D using CNN and KNN machine learning methods and a CNN control with permuted training labels. Thus our CNN can accurately extrapolate predictions for unseen sequences with higher binding affinity than any of the training examples. These results suggest we can use such a model to propose novel sequences that are in fact more effective than those we have profiled. Such accurate extrapolation can massively improve the performance of Bayesian Optimization, and we thus believe our deep learning based variant can uncover highly effective antibodies in much fewer rounds of experimentation than a standard kernel-based implementation.

We then verified that we can produce novel antibody sequences with higher predicted affinity than those previously observed. FIG. 12 is a schematic of how CNN can suggest novel high-scoring sequences. We used the optimal CNN (seq_64×2_5_4) trained on labeled B and C antibody sequences to suggest alternative residues that would lead to higher-scoring sequences starting from a high-scoring sequence (below x-axis). The suggestions are summarized above the axis with residue letters proportional in size to their suggested probability of incorporation. We started with the observed sequence shown at the bottom of FIG. 12 and applied gradient-based optimization which identified sequences with higher predicted affinity. By additionally incorporating posterior uncertainty in the optimization objective, our framework encourages exploration beyond only the sequences already predicted to exhibit superior outcomes.

As another complementary example, we demonstrate how our method can produce novel sequences that have both a high affinity for a first target and low affinity for a second target. The optimization for low affinity to a second target produces sequences that are highly specific for the first target in the presence of the second target. In this example, we use data from panning based page display experiments, where scFv antibody fragments are displayed on phage. Our initial library of phage displayed scFv sequences consisting of a fixed scFv framework with CDR-H3 regions that randomly varied in sequence and length (10-18aa).

We first ran independent phage panning experiments against two targets, Lucentis and Enbrel. The targets are antibodies themselves, with Enbrel being Tumor necrosis factor receptor 2 fused to the Fc of human IgG1, and Lucentis being an anti-VEGF (vascular endothelial growth factor A) humanized Fab-kappa antibody. We performed three rounds of phage panning starting with the initial phage library described above. In each experiment, we sequenced the CDR-H3 region of phage retained after the first round (R1), second round (R2), and third round (R3) of affinity purification. We parsed the sequences and extracted the CDR-H3 variable sequences. After the rejection of poor quality sequence data we observed 11709 positive (positive enrichment) and 75796 negative sequences for Lucentis, and 32601 positive and 5490 negative samples for Enbrel.

We then created a multi-label dataset where each CDR-H3 sequence had two labels, one label for the sequence's enrichment in the Lucentis panning experiment one label for the sequence's enrichment in the Enbrel experiment. The label for Lucentis was the ratio of R3 frequency to R2 frequency to distinguish sequences with high affinity. The label for Enbrel was the ratio of R3 frequency to R1 frequency to distinguish the presence of low affinity binding to Enbrel. For classification tasks enrichments were discretized into binding and non-binding labels. A sequence will be missing a label if its enrichment is not observed in the corresponding panning experiment. Missing labels are assigned to unbound (classification tasks) or assigned to an enrichment of −1 log 10 (regression tasks).

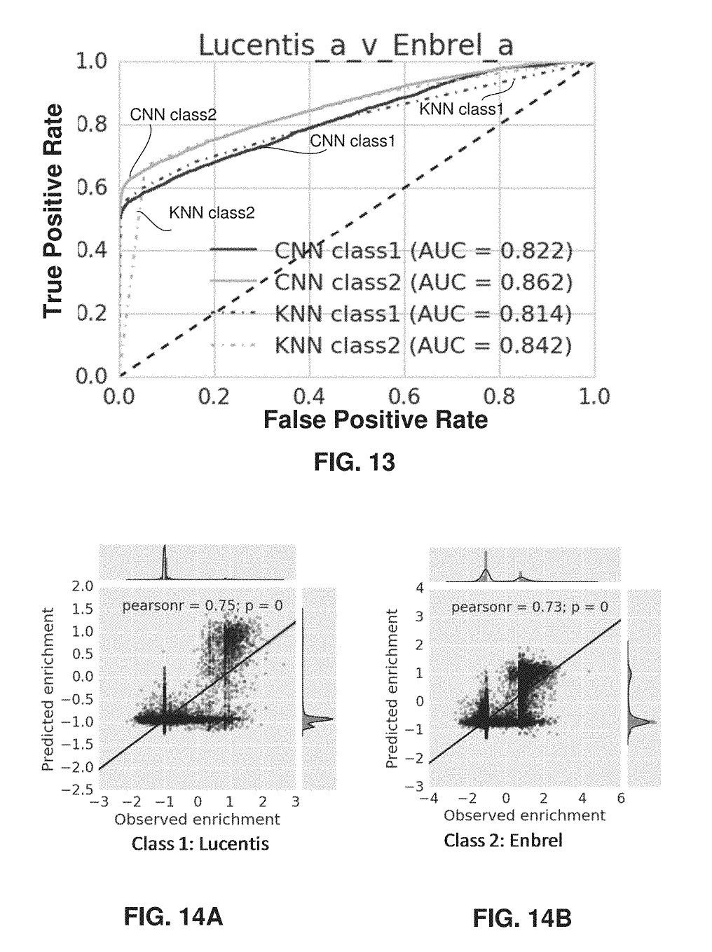

We trained a multi-class CNN deep learning model to simultaneously predict both labels from CDR-H3 sequence. We centered and padded the CDR-H3 sequences into 20 amino acid long sequences using “one-hot” encoding as described in previous experiment. We held out 20% of the sequences randomly, and trained our multi-class CNN on the remaining 80% to jointly predict the labels for Lucentis and Enbrel. We used a CNN architecture with two convolutional layers with 32 convolutional kernels and a window size of 5 residues and a max pooling step size of 5 residues, followed by one fully connected layer with 16 hidden units. As shown in FIG. 13, the auROC is 0.822 for Lucentis and 0.862 for Enbrel. A K-nearest neighbors algorithm with K=5 neighbors had an auROC of 0.814 for Lucentis and 0.842 for Enbrel.

We then trained a multi-output regression CNN to predict observed affinity scores directly, where the affinity score is defined as log 10 of the ratio of R3 frequency to R2 frequency for Lucentis and log 10 of the ratio of R3 frequency to R1 frequency for Enbrel. Predictions for the held-out testing set correlated well with the observed affinity for both targets, with a Pearson R of 0.75 for Lucentis and 0.73 for Enbrel (FIGS. 14A and 14B).

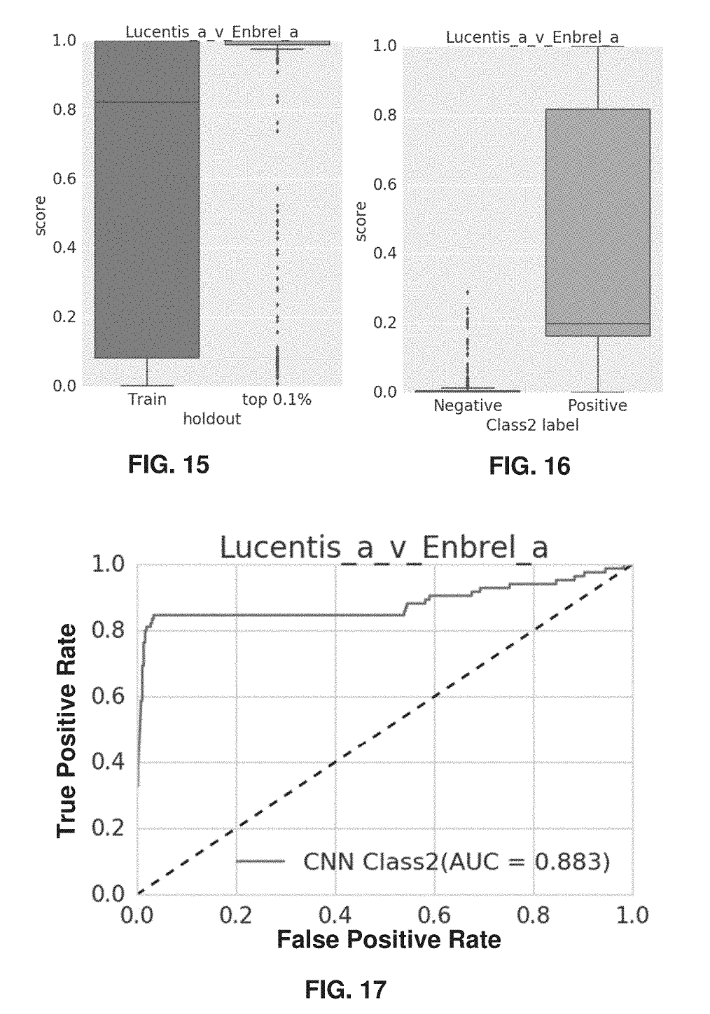

We then validated the potential of our method to propose novel antibody sequences that specifically bind to Lucentis with high affinity that do not bind to Enbrel. Binding is defined as having an enrichment greater than one between relevant panning rounds (Lucentis R3/R2; Enbrel R3/R1). We held out sequences that rank top in the 0.1% of enrichment for Lucentis, where some of the held-out sequences also bind to Enbrel while others do not. Among the held-out 437 sequences, 85 of them bind to Enbrel. We trained a multi-class CNN as previously described on the bottom 99.9% sequences. The resulting trained CNN scores the held-out top 0.1% Lucentis sequences higher than the positive training set for Lucentis (FIG. 15), while sequences that bind both Lucentis and Enbrel were assigned higher Enbrel scores than the Lucentis specific binders (FIG. 16). Within the top 0.1% enriched sequences for Lucentis, the test auROC of Enbrel is 0.883 (FIG. 17). Thus, the multi-class trained CNN can predict Enbrel binding in the context of sequences that all bind Lucentis.

We then ran a gradient ascent based optimization method using the trained multi-label CNN to propose better Lucentis specific binders. Here we set the objective function for gradient ascent to Score(Class 1)−α*Score(Class 2), where a is the hyper parameter that controls the balance between optimizing binding affinity and specificity, Class 1 is Lucentis, and Class 2 is Enbrel. We used training sequences that have positive binding affinity score for both Lucentis and Enbrel as the seed sequences to optimize with gradient ascent.

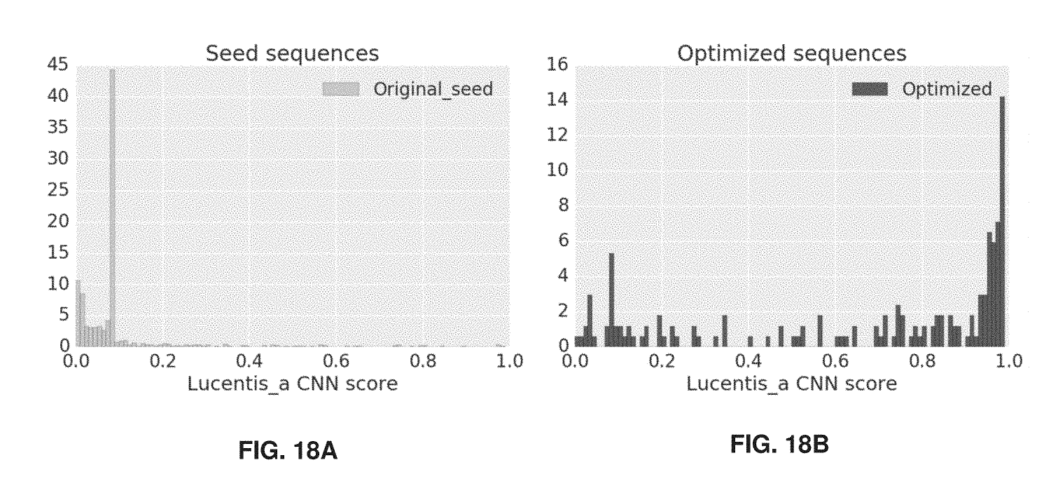

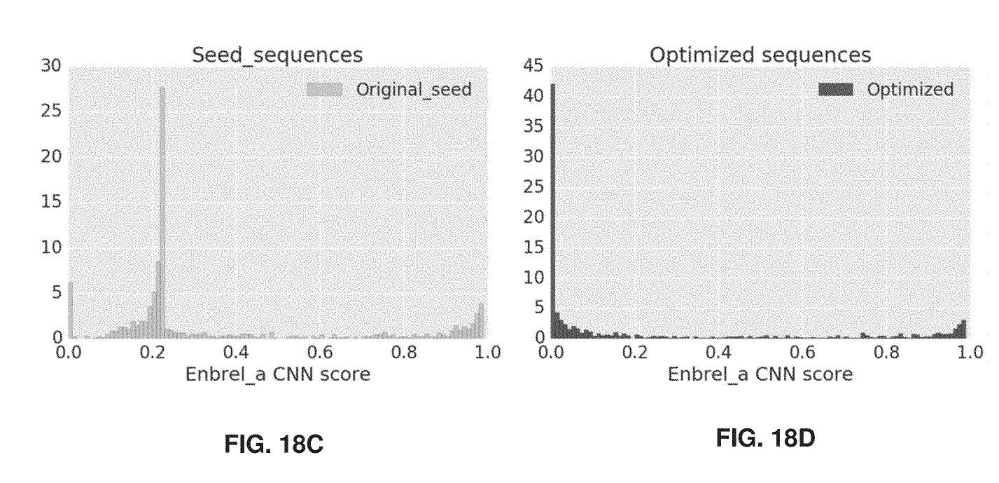

The distribution of predicted binding scores for Class 1 (Lucentis) and Class 2 (Enbrel) shifts to be specific for Lucentis after optimization as shown in FIGS. 18A, 18B, 18C, and 18D. The scores shown on the x-axis are the estimated probabilities that a sequence will bind. As shown in FIGS. 18A and 18B, the Class 1 (Lucentis) score is presented, the proposed sequences have much higher predicted scores for binding to Lucentis after optimization compared to the distribution of starting seed scores, while in FIGS. 18C and 18D the Class 2 (Enbrel) score is shown, the proposed sequences have much lower scores, showing that these sequences are not expected to bind to Enbrel after optimization.

We found that four of our novel optimized Lucentis sequences matched sequences that were held out during training (top 0.1% of Lucentis enrichment), and only one of these sequences bound Enbrel.

### Example Computer-Implemented Embodiments

Any suitable computing device may be used in a system implementing techniques described herein. A computing device may comprise at least one processor, a network adapter, and computer-readable storage media. The computing device may be, for example, a desktop or laptop personal computer, a personal digital assistant (PDA), a smart mobile phone, a server, or any other suitable computing device. The network adapter may be any suitable hardware and/or software to enable the computing device to communicate wired and/or wireles sly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. The computer-readable media may be adapted to store data to be processed and/or instructions to be executed by processor. Processor enables processing of data and execution of instructions. The data and instructions may be stored on the computer-readable storage media and may, for example, enable communication between components of the computing device. The data and instructions stored on computer-readable storage media may comprise computer-executable instructions implementing techniques which operate according to the principles described herein.

A computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

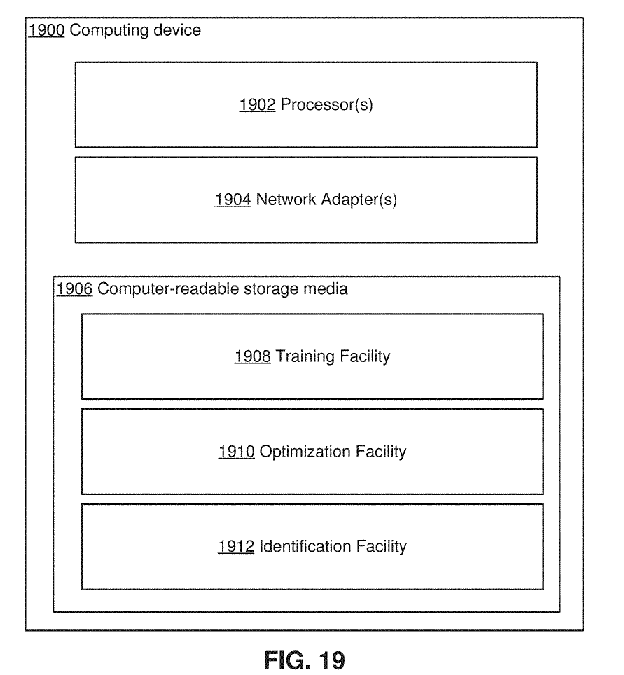

FIG. 19 illustrates one exemplary implementation of a computing device in the form of a computing device 1900 that may be used in a system implementing techniques described herein, although others are possible. Computing device 1900 may operate a sequence analysis device and control the functionality of the sequence analysis device using hardware, software or a combination thereof. When implemented in software, the software code can be executed on any suitable processor or collection of processors, whether provided in a single component or distributed among multiple components. Such processors may be implemented as integrated circuits, with one or more processors in an integrated circuit component. A processor may be implemented using circuitry in any suitable format. Computing device 1900 may be integrated within the sequence analysis device or operate the sequence analysis device remotely. It should be appreciated that FIG. 19 is intended neither to be a depiction of necessary components for a computing device to operate in accordance with the principles described herein, nor a comprehensive depiction.

Computing device 1900 may comprise at least one processor 1902, a network adapter 1904, and computer-readable storage media 1906. Computing device 1900 may be, for example, a desktop or laptop personal computer, a personal digital assistant (PDA), a smart mobile phone, a tablet computer, a server, or any other suitable portable, mobile or fixed computing device. Network adapter 1904 may be any suitable hardware and/or software to enable the computing device 1900 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1906 may be adapted to store data to be processed and/or instructions to be executed by processor 1902. Processor 1902 enables processing of data and execution of instructions.

The data and instructions may be stored on the computer-readable storage media 1906 and may, for example, enable communication between components of the computing device 1900.

The data and instructions stored on computer-readable storage media 1906 may comprise computer-executable instructions implementing techniques which operate according to the principles described herein. In the example of FIG. 19, computer-readable storage media 1906 stores computer-executable instructions implementing various facilities and storing various information as described above. Computer-readable storage media 1906 may store a variant facility 1908, a reference sequence facility 1910, a sequence alignment facility 1912, and a sequence analysis facility 1914 each of which may implement techniques described above.

While not illustrated in FIG. 19 computing device 1900 may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format, through visible gestures, through haptic input (e.g., including vibrations, tactile and/or other forces), or any combination thereof.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

One or more processors may be interconnected by one or more networks in any suitable form, including as a local area network or a wide area network, such as an enterprise network or the Internet. Such networks may be based on any suitable technology and may operate according to any suitable protocol and may include wireless networks, wired networks, or fiber optic networks.

One or more algorithms for controlling methods or processes provided herein may be embodied as a readable storage medium (or multiple readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible storage medium) encoded with one or more programs that, when executed on one or more computers or other processors, perform methods that implement the various methods or processes described herein.

In some embodiments, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the methods or processes described herein. As used herein, the term “computer-readable storage medium” encompasses only a computer-readable medium that can be considered to be a manufacture (e.g., article of manufacture) or a machine. Alternatively or additionally, methods or processes described herein may be embodied as a computer readable medium other than a computer-readable storage medium, such as a propagating signal.

The terms “program” or “software” are used herein in a generic sense to refer to any type of code or set of executable instructions that can be employed to program a computer or other processor to implement various aspects of the methods or processes described herein. Additionally, it should be appreciated that according to one aspect of this embodiment, one or more programs that when executed perform a method or process described herein need not reside on a single computer or processor, but may be distributed in a modular fashion amongst a number of different computers or processors to implement various procedures or operations.

Executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. Non-limiting examples of data storage include structured, unstructured, localized, distributed, short-term and/or long term storage. Non-limiting examples of protocols that can be used for communicating data include proprietary and/or industry standard protocols (e.g., HTTP, HTML, XML, JSON, SQL, web services, text, spreadsheets, etc., or any combination thereof). For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags, or other mechanisms that establish relationship between data elements.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter. Examples of such terms related to shape, orientation, and/or geometric relationship include, but are not limited to terms descriptive of: shape—such as, round, square, circular/circle, rectangular/rectangle, triangular/triangle, cylindrical/cylinder, elliptical/ellipse, (n)polygonal/(n)polygon, etc.; angular orientation—such as perpendicular, orthogonal, parallel, vertical, horizontal, collinear, etc.; contour and/or trajectory—such as, plane/planar, coplanar, hemispherical, semi-hemispherical, line/linear, hyperbolic, parabolic, flat, curved, straight, arcuate, sinusoidal, tangent/tangential, etc.; direction—such as, north, south, east, west, etc.; surface and/or bulk material properties and/or spatial/temporal resolution and/or distribution—such as, smooth, reflective, transparent, clear, opaque, rigid, impermeable, uniform(ly), inert, non-wettable, insoluble, steady, invariant, constant, homogeneous, etc.; as well as many others that would be apparent to those skilled in the relevant arts. As one example, a fabricated article that would described herein as being “ square” would not require such article to have faces or sides that are perfectly planar or linear and that intersect at angles of exactly 90 degrees (indeed, such an article can only exist as a mathematical abstraction), but rather, the shape of such article should be interpreted as approximating a “square,” as defined mathematically, to an extent typically achievable and achieved for the recited fabrication technique as would be understood by those skilled in the art or as specifically described. As another example, two or more fabricated articles that would described herein as being “aligned” would not require such articles to have faces or sides that are perfectly aligned (indeed, such an article can only exist as a mathematical abstraction), but rather, the arrangement of such articles should be interpreted as approximating “aligned,” as defined mathematically, to an extent typically achievable and achieved for the recited fabrication technique as would be understood by those skilled in the art or as specifically described.

1.-54. (canceled)

55. At least one non-transitory computer-readable storage medium storing computer-executable instructions that, when executed by at least one processor, cause the at least one processor to perform a method for identifying an amino acid sequence for a protein having an interaction with a target, the method comprising:
querying a machine learning engine for a proposed amino acid sequence for a protein having a high interaction with the target, wherein the machine learning engine was trained using protein interaction information for different amino acid sequences with the target; and
receiving from the machine learning engine the proposed amino acid sequence, the proposed amino acid sequence indicating a specific amino acid for each residue of the proposed amino acid sequence.

56. The at least one non-transitory computer-readable storage medium of claim 55, wherein the machine learning engine was trained using information identifying a first characteristic and a second characteristic corresponding to each of the different amino acid sequences, and wherein the method further comprises predicting the proposed amino acid sequence by using the first characteristic and the second characteristic to identify a specific amino acid for at least one residue of the proposed amino acid sequence, wherein at least the first characteristic relates to the protein having a high interaction with the target.

57. The at least one non-transitory computer-readable storage medium of claim 56, wherein the machine learning engine was trained to generate a model having a parameter representing a weight between the first characteristic and the second characteristic, and the predicting the proposed amino acid sequence further comprises using the parameter to identify a specific amino acid for at least one residue of the proposed amino acid sequence.

58. The at least one non-transitory computer-readable storage medium of claim 55, wherein the method further comprises determining, using the machine learning engine, the proposed amino acid sequence based on a first characteristic and a second characteristic corresponding to each of the different amino acid sequences, wherein at least the first characteristic relates to the protein having a high interaction with the target.

59. The at least one non-transitory computer-readable storage medium of claim 58, wherein the target is an antigen.

60. The at least one non-transitory computer-readable storage medium of claim 59, wherein the proposed amino acid sequence includes a complementarity-determining region (CDR) of an antibody, and the first characteristic is the antibody's affinity for the antigen.

61. The at least one non-transitory computer-readable storage medium of claim 58, wherein the first characteristic is affinity of an amino acid sequence for the target and the second characteristic is affinity or lack of affinity for a second target.

62. The at least one non-transitory computer-readable storage medium of claim 55, wherein receiving the proposed amino acid sequence comprises:
receiving values associated with different amino acids for each residue of a protein sequence, wherein the values correspond to predictions, generated by the machine learning engine, of interactions of the proposed amino acid sequence with the target if the amino acid is included in the proposed amino acid sequence at the residue; and
identifying the proposed amino acid sequence by selecting, for each residue of the protein sequence, an amino acid for the residue based on the values.

63. The at least one non-transitory computer-readable storage medium of claim 62, wherein identifying the proposed amino acid sequence further comprises selecting an amino acid for a first residue based on an amino acid included in the proposed amino acid sequence at a second residue.

64. The at least one non-transitory computer-readable storage medium of claim 55, wherein the method further comprises:
receiving protein interaction information associated with a protein having the proposed amino acid sequence with the target; and
training the machine learning engine using the protein interaction information.

65. The at least one non-transitory computer-readable storage medium of claim 55, wherein the method further comprises:
predicting a protein interaction level for the proposed amino acid sequence;
comparing the predicted protein interaction level to protein interaction information associated with a protein having the proposed amino acid sequence with the target; and
training the machine learning engine based on a result of the comparison.

66. The at least one non-transitory computer-readable storage medium of claim 55, wherein the method further comprises receiving an initial amino acid sequence for a first protein having an interaction with the target, and wherein querying the machine learning engine further comprises querying the machine learning engine for a proposed amino acid sequence for a second protein having a predicted interaction with the target higher than the first protein.

67. The at least one non-transitory computer-readable storage medium of claim 66, wherein the method further comprises querying, successively to receiving from the machine learning engine the proposed amino acid sequence, the machine learning engine for a second proposed amino acid sequence for a third protein having a predicted interaction with the target higher than the second protein.

68. The at least one non-transitory computer-readable storage medium of claim 66, wherein the method further comprises:
identifying a region of the initial amino acid sequence associated with a protein interaction region of the first protein associated with the initial amino acid sequence; and
querying the machine learning engine further comprises inputting the protein interaction region of the initial amino acid sequence to the machine learning engine.

69. The at least one non-transitory computer-readable storage medium of claim 68, wherein the method further comprises training the machine learning engine using protein interaction data associated with the proposed amino acid sequence and querying the machine learning engine for a second proposed amino acid sequence having a predicted interaction with the target stronger than the interaction of the initial amino acid sequence.

70. A method for identifying an amino acid sequence for a protein having an interaction with a target, the method comprising:
querying a machine learning engine for a proposed amino acid sequence for a protein having a high interaction with the target, wherein the machine learning engine was trained using protein interaction information for different amino acid sequences with the target; and
receiving from the machine learning engine the proposed amino acid sequence, the proposed amino acid sequence indicating a specific amino acid for each residue of the proposed amino acid sequence.

71. The method of claim 70, wherein the machine learning engine was trained using information identifying a first characteristic and a second characteristic corresponding to each of the different amino acid sequences, and wherein the method further comprises predicting the proposed amino acid sequence by using the first characteristic and the second characteristic to identify a specific amino acid for at least one residue of the proposed amino acid sequence, wherein at least the first characteristic relates to the protein having a high interaction with the target.

72. The method of claim 70, wherein receiving the proposed amino acid sequence comprises:
receiving values associated with different amino acids for each residue of a protein sequence, wherein the values correspond to predictions, generated by the machine learning engine, of interactions of the proposed amino acid sequence with the target if the amino acid is included in the proposed amino acid sequence at the residue; and
identifying the proposed amino acid sequence by selecting, for each residue of the protein sequence, an amino acid for the residue based on the values.

73. The method of claim 72, wherein identifying the proposed amino acid sequence further comprises selecting an amino acid for a first residue based on an amino acid included in the proposed amino acid sequence at a second residue.

74. The method of claim 70, wherein the method further comprises receiving an initial amino acid sequence for a first protein having an interaction with the target, and wherein querying the machine learning engine further comprises querying the machine learning engine for a proposed amino acid sequence for a second protein having a predicted interaction with the target higher than the first protein.

75. The method of claim 70, wherein the method further comprises:
receiving protein interaction information associated with a protein having the proposed amino acid sequence with the target; and
training the machine learning engine using the protein interaction information.

76. The method of claim 70, wherein the method further comprises:
predicting a protein interaction level for the proposed amino acid sequence;
comparing the predicted protein interaction level to protein interaction information associated with a protein having the proposed amino acid sequence with the target; and
training the machine learning engine based on a result of the comparison.

77. The method of claim 70, wherein the method further comprises receiving an initial amino acid sequence for a first protein having an interaction with the target, and wherein querying the machine learning engine further comprises querying the machine learning engine for a proposed amino acid sequence for a second protein having a predicted interaction with the target higher than the first protein.

78. The method of claim 77, wherein the method further comprises:
identifying a region of the initial amino acid sequence associated with a protein interaction region of the first protein associated with the initial amino acid sequence; and
querying the machine learning engine further comprises inputting the protein interaction region of the initial amino acid sequence to the machine learning engine.

79. A system comprising control circuitry configured to perform a method for identifying an amino acid sequence for a protein having an interaction with a target, the method comprising:
receiving an initial amino acid sequence for a protein having a first characteristic and a second characteristic;
training a machine learning engine using data that includes a plurality of amino acid sequences and information identifying a first characteristic and a second characteristic corresponding to each of the plurality of amino acid sequences; and
querying the trained machine learning engine for a proposed amino acid sequence of a protein having an interaction with the target that differs from the initial amino acid sequence, wherein the querying the machine learning engine comprises:
predicting the proposed amino acid sequence by using the first characteristic and the second characteristic to identify a specific amino acid for at least one residue of the proposed amino acid sequence; and
receiving from the machine learning engine the proposed amino acid sequence.

80. The system of claim 79, wherein training the machine learning engine includes generating a model having a parameter representing a weight between the first characteristic and the second characteristic and assigning scores for the first characteristic and the second characteristic corresponding to each of the plurality of amino acid sequences, and the predicting the proposed amino acid sequence further comprises estimating, using the scores, a value for the parameter and using the value of the parameter to identify a specific amino acid for at least one residue of the proposed amino acid sequence.

81. The system of claim 80, wherein the predicting the proposed amino acid sequence comprises applying a gradient optimization process to the scores for the first characteristic and the second characteristic to determine the proposed amino acid sequence.

82. The system of claim 79, wherein predicting the proposed amino acid sequence further comprises:
identifying a representation of an amino acid sequence having a plurality of values corresponding to different amino acids located at each residue in the amino acid sequence; and
selecting, based on the plurality of values, a single amino acid for each residue to determine the proposed amino acid sequence.

83. The system of claim 79, wherein the predicting the proposed amino acid sequence further comprises:
receiving, from the machine learning engine, an output amino acid series and values associated with different amino acids for each residue of the output amino acid series, wherein the values for each amino acid for each residue correspond to predictions of the machine learning engine regarding levels of the first characteristic and the second characteristic if the amino acid is selected for the residue;
identifying a discrete version of the output amino acid series by selecting, for each residue, an amino acid from among the different amino acids for the residue based on the values; and
receiving, as an output of identifying the discrete version, the proposed amino acid sequence.

84. The system of claim 83, wherein:
the querying, the receiving the output amino acid series, and the identifying the discrete version of the output amino acid series form at least part of an iterative process;
wherein the predicting the proposed amino acid sequence further comprises at least one additional iteration of the iterative process, wherein in each iteration, the querying comprises inputting to the machine learning engine the discrete version of the output amino acid series from an immediately prior iteration.
